(19) United States
(12) Patent Application Publication
(10) Pub. No.: US 2014/0092979 A1
(43) Pub. Date: Apr. 3, 2014

(54) IMAGE PROCESSING APPARATUS AND METHOD

(71) Applicant: Kazushi Sato, Tokyo (JP)

(72) Inventor: Kazushi Sato, Tokyo (JP)

(73) Assignee: Sony Corporation, Tokyo (JP)

(21) Appl. No.: 14/116,493

(22) PCT Filed: May 11, 2012
(86) PCT No.: PCT/JP2012/062085

§ 371 Date: Nov. 8, 2013

(30) Foreign Application Priority Data
May 18, 2011 (JP) 2011-111576

(51) Int. Cl. H04N 7/36

(52) U.S. Cl. CPC H04N 19/00684
USPC 375/240.16

(57) ABSTRACT

This technique relates to an image processing apparatus and a method for improving the coding efficiency. The image processing device includes a weight mode determination unit configured to determine, for each predetermined region, a weight mode which is a mode of weight prediction in which inter-motion prediction compensation processing for coding an image is performed while giving weight with a weight coefficient, a weight mode information generation unit configured to generate, for each of the regions, weight mode information indicating a weight mode determined by the weight mode determination unit, and an encoding unit configured to encode the weight mode information generated by the weight mode information generation unit. The present disclosure can be applied to an image processing apparatus.

### TECHNICAL FIELD

The present disclosure relates to an image processing apparatus and a method, and more particularly, to an image processing apparatus and a method capable of improving the coding efficiency.

### BACKGROUND ART

In recent years, image information is treated as digital, and at this occasion, for the purpose of transmitting and accumulating information with a high degree of efficiency, apparatuses based on a method such as MPEG (Moving Picture Experts Group) for compression based on orthogonal transformation such as discrete cosine transform and motion compensation by making use of redundancy unique to image information become widely available in not only information distribution such as broadcast station but also information reception at ordinary households.

In particular, MPEG2 (ISO (International Organization for Standardization)/IEC (International Electrotechnical Commission) 13818-2) is defined as a general-purpose image coding method, and with a standard covering both of an interlaced scanned image and sequentially scanned image and a standard resolution image and a high-definition image, it is now widely used for wide range of applications for professionals and consumers. When the MPEG2 compression method is used, high compression rate and high image quality can be achieved by allocating, for example, 4 to 8 Mbps as an amount of codes (bit rate) for an interlaced scanned image of a standard resolution having 720 by 480 pixels and 18 to 22 Mbps for an interlaced scanned image of a high resolution having 1920 by 1088 pixels.

MPEG2 is mainly targeted for high image quality coding suitable for broadcasting, but does not support coding method of a less amount of codes (bit rate) than MPEG1. In other words, MPEG2 does not support higher compression rate. As portable terminals become widely prevalent, needs for such coding methods are considered to grow in the future, and in order to respond to such needs, MPEG4 coding method has been standardized. With regard to image coding method, the specification is admitted as ISO/IEC 14496-2 in international standard on December, 1998.

Further, in recent years, a standard called H.26L (ITU-T (International Telecommunication Union Telecommunication Standardization Sector) Q6/16 VCEG (Video Coding Expert Group)) is standardized for the purpose of image coding for teleconference in the first place. As compared with conventional coding methods such as MPEG2 and MPEG4, H.26L is known to require a higher amount of computation in coding and decoding thereof, but achieve a still higher degree of coding efficiency. In addition, currently, as one of activities of MPEG4, standardization of achieving a still higher degree of efficiency based on H.26L by incorporating functions not supported by H.26L is being done in Joint Model of Enhanced-Compression Video Coding.

With regard to the schedule of standardization, it was made into international standard under the name of H.264 and MPEG-4 Part10 (Advanced Video Coding, hereinafter referred to as AVC) on March, 2003.

Further, as an expansion thereto, standardization of FRExt (Fidelity Range Extension) including 8 by 8 DCT (Discrete Cosine Transform) and quantization matrix defined by MPEG-2 and coding to required for business such as RGB, 4:2:2, and 4:4:4 is completed on February, 2005, and therefore, using AVC, this is made into a coding method capable of expressing film noise included in movies in a preferable manner and is beginning to be used in wide range of applications such as Blu-Ray Disc.

However, recently, the needs for coding with a still higher degree of compression rate are growing. For example, it is desired to compress an image of about 4000 by 2000 pixels which is four times the high vision image or distribute high vision image in a limited transmission capacity environment such as the Internet. Therefore, in VCEG (Video Coding Expert Group) under ITU-T, improvement of the coding efficiency is continuously considered.

By the way, as described above, making a macro block size of 16 pixel by 16 pixels may not be suitable for a large image frame such as UHD (Ultra High Definition; 4000 pixel by 2000 pixels) which is a target of next-generation coding method.

Accordingly, currently, in order to further improve coding efficiency at a level higher than AVC, JCTVC (Joint Collaboration Team-Video Coding) which is a joint standards organization of ITU-T and ISO/TEC has been working on making standards of encoding method called HEVC (High Efficiency Video Coding) (for example, see Non-Patent Document 1).

In this HEVC encoding method, coding unit (CU) is defined as the same processing unit as the macro block in the AVC. The size of this CU is not limited to 16 by 16 pixels unlike the macro block of the AVC, and in each sequence, is designated in image compression information.

By the way, in MPEG2 and MPEG4, for example, motion exists like fade scene, but in a sequence where brightness changes, no encoding tool is prepared to absorb change of the brightness, and therefore, there is a problem in that the coding efficiency is reduced.

In order to solve such problem, in the AVC, weight prediction processing is provided (for example, see Non-Patent Document 2). In the AVC, in units of slices, whether or not this weight prediction is used or not can be designated.

### CITATION LIST

### Non-Patent Documents

Non-Patent Document 1: Thomas Wiegand, Woo-Jin Han, Benjamin Bross, Jens-Rainer Ohm, Gary J. Sullivan, “Working Draft 1 of High-Efficiency Video Coding”, JCTVC-C403, Joint Collaborative Team on Video Coding (JCT-VC) of ITU-T SG16 WP3 and ISO/IEC JTC1/SC29/WG113rd Meeting: Guangzhou, CN, 7-15 Oct. 2010
Non-Patent Document 2: Yoshihiro Kikuchi, Takeshi Chujoh, “Improved multiple frame motion compensation using frame interpolation”, JVT-B075, Joint Video Team (JVT) of ISO/IEC MPEG & ITU-T VCEG(ISO/IEC JTC1/SC29/WG11 and ITU-T SG16 Q.6) 2nd Meeting: Geneva, CH, Jan. 29-Feb. 1, 2002

### SUMMARY OF THE INVENTION

### Problems to be Solved by the Invention

By the way, brightness change may occur in a part of a screen, but there may be no change in the other portions. However, weight prediction in the AVC is unable to cope with this, and therefore, the efficiency of the weight prediction is reduced. For example, in an image such as a letter box in which end portions of a screen is an image painted in black where there is no brightness change, even if brightness change occurs in the center of the screen, applying the weight prediction to the entire picture is not appropriate at end portions of the screen where there is no brightness change, and the coding efficiency may be reduced. Even when the brightness change does not uniformly change in the entire screen, the prediction precision of the weight prediction is partially reduced, and this may cause reduction of the coding efficiency.

The present disclosure is made in view of such circumstances, and it is an object thereof to able to suppress reduction of the prediction precision of weight prediction and suppress reduction of coding efficiency by reducing the size of area for the control unit of the weight prediction.

### Solutions to Problems

An aspect of the present disclosure is an image processing device including a weight mode determination unit configured to determine, for each predetermined region, a weight mode which is a mode of weight prediction in which inter-motion prediction compensation processing for coding an image is performed while giving weight with a weight coefficient, a weight mode information generation unit configured to generate, for each of the regions, weight mode information indicating a weight mode determined by the weight mode determination unit, and an encoding unit configured to encode the weight mode information generated by the weight mode information generation unit.

The weight mode may include weight ON mode in which the inter-motion prediction compensation processing is performed using the weight coefficient and weight OFF mode in which the inter-motion prediction compensation processing is performed without using the weight coefficient.

The weight mode may include a mode using the weight coefficient and performing the inter-motion prediction compensation processing in Explicit mode for transmitting the weight coefficient and a mode using the weight coefficient and performing the inter-motion prediction compensation processing in Implicit mode for not transmitting the weight coefficient.

The weight mode may include multiple weight ON modes for performing the inter-motion prediction compensation processing using weight coefficients which are different from each other.

The weight mode information generation unit may generate, instead of the weight mode information, mode information indicating a combination of the weight mode and an inter-prediction mode indicating a mode of the inter-motion prediction compensation processing.

The image processing device may further include a limiting unit for limiting the size of the region for which the weight mode information generation unit generates the weight mode information.

The region may be a region of processing of the inter-motion prediction compensation processing.

The region may be Largest Coding Unit, Coding Unit, or Prediction Unit.

The encoding unit may encode the weight mode information by CABAC.

An aspect of the present disclosure is an image processing method of an image processing device, wherein a weight mode determination unit determines, for each predetermined region, a weight mode which is a mode of weight prediction in which inter-motion prediction compensation processing for coding an image is performed while giving weight with a weight coefficient, a weight mode information generation unit generates, for each of the regions, weight mode information indicating a weight mode determined by the weight mode determination unit, and an encoding unit encodes the weight mode information generated.

Another aspect of the present disclosure is an image processing device, wherein during coding of an image, a weight mode which is a mode of weight prediction in which inter-motion prediction compensation processing is performed while giving weight with a weight coefficient is determined, for each predetermined region, weight mode information indicating a weight mode is generated for each of the regions, and a bit stream encoded together with the image is decoded, the image processing device comprises: a decoding unit configured to extract the weight mode information included in the bit stream; and a motion compensation unit configured to generate a prediction image by performing motion compensation processing in a weight mode indicated in the weight mode information extracted through decoding by the decoding unit.

The weight mode may include weight ON mode in which the inter-motion prediction compensation processing is performed using the weight coefficient and weight OFF mode in which the motion compensation processing is performed without using the weight coefficient.

The weight mode may include a mode in which, using the weight coefficient, the motion compensation processing is performed in Explicit mode for transmitting the weight coefficient and a mode in which, using the weight coefficient, the motion compensation processing is performed in Inplicit mode for not transmitting the weight coefficient.

The weight mode may include multiple weight ON modes for performing the motion, compensation processing using weight coefficients which are different from each other.

In a case of Inplicit mode not transmitting the weight coefficient, the image processing device may further include a weight coefficient calculation unit configured to calculate the weight coefficient.

The image processing device may further include a limitation information obtaining unit configured to obtain limitation information limiting a size of a region where weight mode information exists.

The region may be a region of processing unit of the inter-motion prediction compensation processing.

The region may be Largest Coding Unit, Coding Unit, or Prediction Unit.

A bit stream including the weight mode information may be encoded by CABAC, and the decoding unit may decode the bit stream by CABAC.

Another aspect of the present disclosure is an image processing method for an image processing unit, wherein during coding of an image, a weight mode which is a mode of weight prediction in which inter-motion prediction compensation processing is performed while giving weight with a weight coefficient is determined, for each predetermined region, weight mode information indicating a weight mode is generated for each of the regions, the image processing method comprises:

causing the decoding unit to decode a bit stream encoded together with the image, and extract the weight node information included in the bit stream; and causing a motion compensation unit to generate a prediction image by performing motion compensation processing in a weight mode indicated in the weight mode information extracted through decoding.

In an aspect of the present disclosure, a weight mode which is a mode of weight prediction in which inter-motion prediction compensation processing for coding an image is performed while giving weight with a weight coefficient is determined for each predetermined region, weight mode information indicating a weight mode determined is generated for each of the regions, and the weight mode information generated is encoded.

In another aspect of the present disclosure, during coding of an image, a weight mode which is a mode of weight prediction in which inter-motion prediction compensation processing is performed while giving weight with a weight coefficient is determined, for each predetermined region, weight mode information indicating a weight mode is generated for each of the regions, a bit stream encoded together with the image is decoded, and the weight mode information included in the bit stream is extracted, and a prediction image is generated by performing motion compensation processing in a weight mode indicated in the weight mode information extracted through decoding.

### Effects of the Invention

According to the present disclosure, an image can be processed. In particular, the coding efficiency can be improved.

### BRIEF DESCRIPTION OF DRAWINGS

FIG. 1 is a block diagram illustrating an example of main configuration of an image coding device.

FIG. 2 is a figure illustrating an example of motion prediction/compensation processing of decimal point pixel precision.

FIG. 3 is a figure illustrating an example of a macro block.

FIG. 4 is a figure for explaining an example of median operation.

FIG. 5 is a figure for explaining an example of multi reference frame.

FIG. 6 is a figure for explaining an example of motion search method.

FIG. 7 is a figure for explaining an example of weight prediction.

FIG. 8 is a figure for explaining an example of configuration of a coding unit.

FIG. 9 is a figure for explaining an example of an image.

FIG. 10 is a block diagram for explaining an example of main configuration of a motion prediction/compensation unit, a weight prediction unit, and a weight mode determination unit of an image coding device.

FIG. 11 is a flowchart for explaining an example of a flow of coding processing.

FIG. 12 is a flowchart for explaining an example of a flow of inter-motion prediction processing of the coding processing.

FIG. 13 is a block diagram for explaining an example of main configuration of an image decoding device.

FIG. 14 is a block diagram for explaining an example of main configuration of a motion prediction/compensation unit of an image decoding device.

FIG. 15 is a flowchart for explaining an example of a flow of decoding processing.

FIG. 16 is a flowchart for explaining an example of a flow of prediction processing.

FIG. 17 is a flowchart for explaining an example of a flow of inter-motion prediction processing of prediction processing.

FIG. 18 is a block diagram for explaining another example of configuration of a motion prediction/compensation unit, a weight prediction unit, and a weight mode determination unit of an image coding device, and an example of configuration of a region size limiting unit.

FIG. 19 is a flowchart for explaining another example of a flow of inter-motion prediction processing of the coding processing.

FIG. 20 is a block diagram for explaining another example of configuration of a motion prediction/compensation unit of an image decoding device.

FIG. 21 is a flowchart for explaining an example of a flow of inter-motion prediction processing of prediction processing.

FIG. 22 is a block diagram for explaining still another example of a motion prediction/compensation unit and a weight prediction unit of an image coding device.

FIG. 23 is a flowchart for explaining still another example of a flow of inter-motion prediction processing of coding processing.

FIG. 24 is a block diagram for explaining still another example of configuration of a motion prediction/compensation unit, a weight prediction unit, and a weight mode determination unit of an image coding device.

FIG. 25 is a flowchart for explaining still another example of a flow of inter-motion prediction processing of coding processing.

FIG. 26 is a block diagram for explaining an example of main configuration of a personal computer.

FIG. 27 is a block diagram illustrating an example of schematic configuration of a television device.

FIG. 28 is a block diagram illustrating an example of schematic configuration of a cellular phone.

FIG. 29 is a block diagram illustrating an example of schematic configuration of a recording/reproducing device.

FIG. 30 is a block diagram illustrating an example of schematic configuration of an image-capturing device.

### MODES FOR CARRYING OUT THE INVENTION

Hereinafter, modes for carrying out the present invention (hereinafter referred to as embodiments) will be explained. It should be noted that the explanation will be made in the following order.

1. First embodiment (image coding device)
2. Second embodiment (image decoding device)
3. Third embodiment (image coding device)
4. Fourth embodiment (image decoding device)
5. Fifth embodiment (image coding device)
6. Sixth embodiment (image coding device)
7. Seventh embodiment (personal computer)
8. Eighth embodiment (television receiver)
9. Ninth embodiment (cellular phone)
10. Tenth embodiment (recording/reproducing device)
11. Eleventh embodiment (image-capturing device)

### 1. First Embodiment

### Image Coding Device

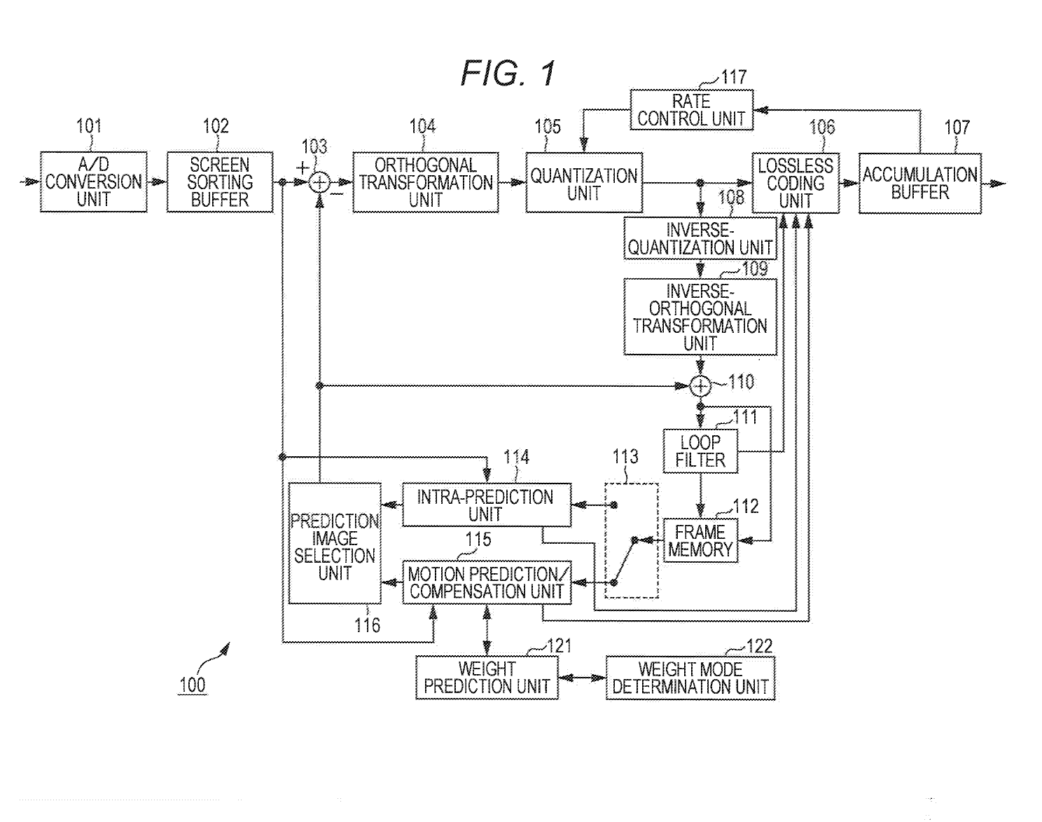

FIG. 1 is a block diagram illustrating an example of main configuration of an image coding device.

An image coding device 100 as illustrated in FIG. 1 encodes image data using prediction processing like H.264 and MPEG (Moving Picture Experts Group) 4 Part10 (AVG (Advanced Video Coding)) coding method.

As illustrated in FIG. 1, the image coding device 100 includes an A/D conversion unit 101, a screen sorting buffer 102, a calculation unit 103, an orthogonal transformation unit 104, a quantization unit 105, a lossless coding unit 106, and an accumulation buffer 107. The image coding device 100 includes an inverse-quantization unit 108, an inverse-orthogonal transformation unit 109, a calculation unit 110, a loop filter 111, a frame memory 112, a selection unit 113, an intra-prediction unit 114, a motion prediction/compensation unit 115, a prediction image selection unit 116, and a rate control unit 117.

Further, the image coding device 100 includes a weight prediction unit 121 and a weight mode determination unit 122.

The A/D conversion unit 101 performs A/D conversion on received image data, and provides converted image data (digital data) to the screen sorting buffer 102 to store the image data therein. The screen sorting buffer 102 sorts images of frames in the stored display order into the order of frames for coding in accordance with GOP (Group Of Picture), and provides the images of which frame order has been sorted to the calculation unit 103. The screen sorting buffer 102 also provides the images of which frame order has been sorted to the intra-prediction unit 114 and the motion prediction/compensation unit 115.

The calculation unit 103 subtracts a prediction image, which is provided from the intra-prediction unit 114 or the motion prediction/compensation unit 115 via the prediction image selection unit 116, from an image read from the screen sorting buffer 102, and provides difference information thereof to the orthogonal transformation unit 104.

For example, in a case of an intra-coded image, the calculation unit 103 subtracts a prediction image, which is provided from the intra-prediction unit 114, from an image read from the screen sorting buffer 102. For example, in a case of an inter-coded image, the calculation unit 103 subtracts a prediction image, which is provided from the motion prediction/compensation unit 115, from an image read from the screen sorting buffer 102.

The orthogonal transformation unit 104 applies orthogonal transformation such as discrete cosine transform and Karhunen-Loeve conversion on difference information provided from the calculation unit 103. It should be noted that the method of this orthogonal transformation may be any method. The orthogonal transformation unit 104 provides conversion coefficients to the quantization unit 105.

The quantization unit 105 quantizes the conversion coefficients from the orthogonal transformation unit 104. The quantization unit 105 sets and quantizes the quantization parameter on the basis of information about a target value of the amount of codes provided from the rate control unit 117. It should be noted that the method of quantization may be any method. The quantization unit 105 provides the quantized conversion coefficients to the lossless coding unit 106.

The lossless coding unit 106 encodes the conversion coefficients quantized by the quantization unit 105 using any coding method. The coefficient data are quantized under the control of the rate control unit 117, and therefore, the amount of codes becomes a target value set by the rate control unit 117 (or becomes close to the target value).

The lossless coding unit 106 obtains intra-prediction information including information indicating mode of intra-prediction and the like from the intra-prediction unit 114, and obtains inter-prediction information including information indicating mode of inter-prediction, motion vector information, and the like from the motion prediction/compensation unit 115. Further, the lossless coding unit 106 obtains filter coefficients and the like used by the loop filter 111.

The lossless coding unit 106 encodes various kinds of information as described above using any coding method, and makes them into a part of header information of coded data (multiplexing). The lossless coding unit 106 provides the coded data obtained from coding to the accumulation buffer 107 to accumulate the coded data therein.

Examples of coding methods of the lossless coding unit 106 include variable length coding or arithmetic coding. An example of variable length coding includes CAVLC (Context-Adaptive Variable Length Coding) and the like defined in H.264/AVC method. An example of arithmetic coding includes CABAC (Context-Adaptive Binary Arithmetic Coding).

The accumulation buffer 107 temporarily holds coded data provided by the lossless coding unit 106. With predetermined timing, the accumulation buffer 107 outputs the coded data held therein, as a bit stream, to, for example, a recording device (recording medium), a transmission path, and the like, not shown, provided in a later stage.

The conversion coefficients quantized by the quantization unit 105 is also provided to the inverse-quantization unit 108. The inverse-quantization unit 108 dequantizes the quantized conversion coefficients according to a method corresponding to the quantization by the quantization unit 105. The method of the inverse-quantization may be any method as long as it is a method corresponding to the quantization processing by the quantization unit 105. The inverse-quantization unit 108 provides the obtained conversion coefficients to the inverse-orthogonal transformation unit 109.

The inverse-orthogonal transformation unit 109 performs inverse-orthogonal transformation on the conversion coefficients provided by the inverse-quantization unit 108 according to a method corresponding to the orthogonal transformation processing by the orthogonal transformation unit 104. The method of the inverse-orthogonal transformation may be any method as long as it is a method corresponding to the orthogonal transformation processing by the orthogonal transformation unit 104. The output obtained from the inverse-orthogonal transformation (locally restored difference information) is provided to the calculation unit 110.

The calculation unit 110 adds a prediction image, which is provided from the intra-prediction unit 114 or the motion prediction/compensation unit 115 via the prediction image selection unit 116, to the inverse-orthogonal transformation result provided from the inverse-orthogonal transformation unit 109, i.e., locally restored difference information, and obtains locally reconfigured image (reconfigured image). The reconfigured image is provided to the loop filter 111 or the frame memory 112.

The loop filter 111 includes a deblock filter, an adaptive loop filter, and the like, and applies filter processing to the decoded image provided from the calculation unit. 110 as necessary. For example, the loop filter 111 applies deblock filter processing to the decoded image to remove block noise from the decoded image. For example, the loop filter 111 applies loop filter processing to the deblock filter processing result (decoded image from which only the block noise has been removed) using Wiener Filter, thus improving the image equality.

It should be noted that the loop filter 111 may apply any given filter processing to the decoded image. As necessary, the loop filter 111 provides information such as filter coefficients used in the filter processing to the lossless coding unit 106 to have the lossless coding unit 106 encode it.

The loop filter 111 provides filter processing result (hereinafter referred to as decoded image) to the frame memory 112.

The frame memory 112 stores the reconfigured image provided from the calculation unit 110 and the decoded image provided from the loop filter 111. The frame memory 112 provides the stored reconfigured image to the intra-prediction unit 114 via the selection unit 113 with predetermined timing or on the basis of external request such as the intra-prediction unit 114. The frame memory 112 provides the stored decoded image to the motion prediction/compensation unit 115 via the selection unit 113 with predetermined timing or on the basis of external request such as the motion prediction/compensation unit 115.

The selection unit 113 indicates the destination of the image which is output from the frame memory 112. For example, in a case of intra-prediction, the selection unit 113 reads a not yet filtered image (reconfigured image) from the frame memory 112, and provides it as surrounding pixels to the intra-prediction unit 114.

For example, in a case of inter-prediction, the selection unit 113 reads a filtered image (decoded image) from the frame memory 112, and provides it as the reference image to the motion prediction/compensation unit 115.

When the intra-prediction unit 114 obtains an image of a surrounding region around a processing target region (surrounding image) from the frame memory 112, the intra-prediction unit 114 uses pixel values in the surrounding image to perform intra-prediction (prediction within screen) for generating a prediction image by basically adopting a prediction unit (PU) as a processing unit. The intra-prediction unit 114 performs this intra-prediction with multiple modes prepared in advance (intra-prediction modes).

The intra-prediction unit 114 generates prediction images with all the intra-prediction modes which can be candidates, and uses an input image provided from the screen sorting buffer 102 to evaluate cost function value of each prediction image, thus selecting the optimum mode. When the optimum intra-prediction mode is selected, the intra-prediction unit 114 provides the prediction image generated with the optimum mode to the prediction image selection unit 116.

The intra-prediction unit 114 provides intra-prediction information including information indicating the optimum intra-prediction mode to the lossless coding unit 106 as necessary, and have the lossless coding unit 106 to perform encoding.

The motion prediction/compensation unit 115 uses the input image provided from the screen sorting buffer 102 and the reference image provided from the frame memory 112 to perform motion prediction (inter-prediction) by basically adopting the PU as a processing unit, performs motion compensation processing in accordance with a detected motion vector, and generates a prediction image (inter-prediction image information). The motion prediction/compensation unit 115 performs such inter-prediction with multiple modes prepared in advance (inter-prediction mode).

The motion prediction/compensation unit 115 generates prediction images with all the inter-prediction modes which can be candidates, and evaluates cost function value of each prediction image, thus selecting the optimum mode. When the optimum inter-prediction mode is selected, the motion prediction/compensation unit 115 provides the prediction image generated with the optimum mode to the prediction image selection unit 116.

The motion prediction/compensation unit 115 provides inter-prediction information including information indicating the optimum inter-prediction mode to the lossless coding unit 106, and have the lossless coding unit 106 perform encoding.

The prediction image selection unit 116 selects the source of the prediction image provided to the calculation unit 103 and the calculation unit 110. For example, in a case of intra-coding, the prediction image selection unit 116 selects the intra-prediction unit 114 as a source of prediction image, and provides a prediction image, which is provided from the intra-prediction unit 114, to the calculation unit 103 and the calculation unit 110. For example, in a case of inter-coding, the prediction image selection unit 116 selects the motion prediction/compensation unit 115 as a source of prediction image, and provides a prediction image, which is provided from the motion prediction/compensation unit 115 to the calculation unit 103 and the calculation unit 110.

The rate control unit 117 controls the rate of the quantization operation of the quantization unit 105 so as not to cause overflow and underflow, on the basis of the amount of codes of the coded data accumulated in the accumulation buffer 107.

The weight prediction unit 121 performs processing concerning weight prediction in the inter-prediction mode performed by the motion prediction/compensation unit 115. The weight mode determination unit 122 determines the optimum mode for the weight prediction performed by the weight prediction unit 121.

The weight prediction unit 121 and the weight mode determination unit 122 control the mode of the weight prediction using a unit smaller than slice as the processing unit. By doing so, the image coding device 100 can improve the prediction precision of the weight prediction, and improve the coding efficiency.

### [Quarter-Pel Motion Prediction]

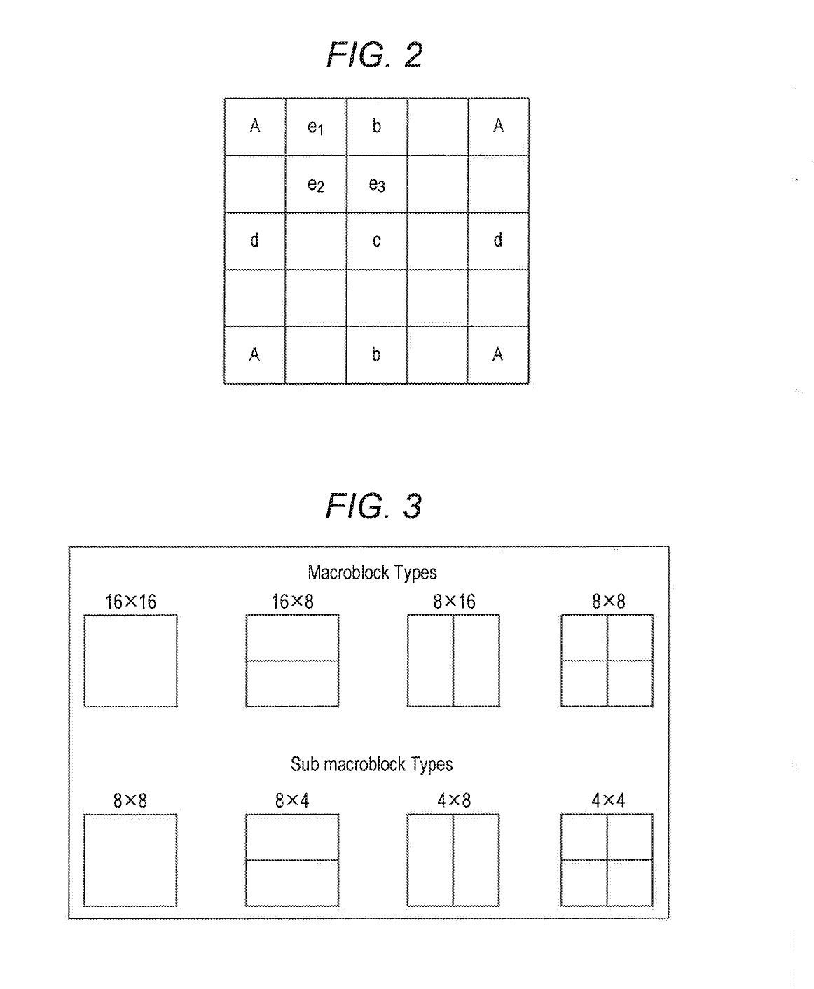

FIG. 2 is a figure for explaining an example of motion prediction/compensation processing of quarter-pel defined in AVC encoding method. In FIG. 2, each rectangle denotes a pixel. Among them, A denotes the position of integer precision pixel stored in the frame memory 112, and b, c, d denote the positions of half-pel, and e1, e2, e3 denote the positions of quarter-pel.

In the explanation below, a function Clip1 ( ) is defined as shown in the following expression (1).

$$\begin{matrix}[ Numerical expression 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

For example, when an input image is of 8 bit precision, the value of max_pix in expression (1) [symbol] max_pix is 255.

The pixel values at the positions of b and d are generated as shown in expression (2) and expression (3) below using 6 tap FIR filter.

[Numerical expression 2]

F=A₋₂−5·A₋₁+20·A₀+20·A₁−5·A₂+A₃ (2)

[Numerical expression 3]

b,d=Clip1((F+16)>>5) (3)

The pixel values at the position of c is generated as shown in expression (4) to expression (6) below applying 6 tap FIR filter in the horizontal direction and vertical direction.

[Numerical expression 4]

F=b₋₂−5·b₋₁+20·b₀+20·b₁−5·b₂+b₃ (4)

or

[Numerical expression 5]

F=d₋₂−5·d₋₁+20·d₀+20·d₁−5·d₂+d₃ (5)

[Numerical expression 6]

c=Clip1((F+512)>>10) (6)

It should be noted that Clip processing is performed only once at last after performing both of multiply and accumulation processing in the horizontal direction and vertical direction.

e1 to e3 are generated by linear interpolation as shown in expression (7) to expression (9) below.

[Numerical expression 7]

e₁=(A+b+1)>>1 (7)

[Numerical expression 8]

e₂=(b+d+i)>>1 (8)

[Numerical expression 9]

e₃=(b+c+1)>>1 (9)

### [Macro Block]

In MPEG2, the unit of the motion prediction/compensation processing are as follows: in a case of frame motion compensation mode, the unit is 16 by 16 pixels, and in a case of field motion compensation mode, the motion prediction/compensation processing is performed on each of the first field and the second field with 16 by 8 pixels being the unit.

In contrast, in the AVC, as shown in FIG. 3, one macro block constituted by 16 by 16 pixels is divided into any one of partitions of 16 by 16, 16 by 8, 8 by 16, or 8 by 8, and for each sub-macro block, motion vector information independent from each other may be provided. Further, as shown in FIG. 3, 8 by 8 partition may be divided into any one of sub-macro blocks of 8 by 8, 8 by 4, 4 by 8, 4 by 4, and motion vector information independent from each other may be provided for each of them.

However, when, in the AVC image encoding method, such motion prediction/compensation processing is performed like the case of MPEG2, an enormous amount of motion vector information may be generated. Then, encoding the generated motion vector information as it is may result in reduction of the coding efficiency.

### [Median Prediction of Motion Vector]

As a method for solving such problem, the AVC image coding achieves reduction of coded information of the motion vector according to the method described below.

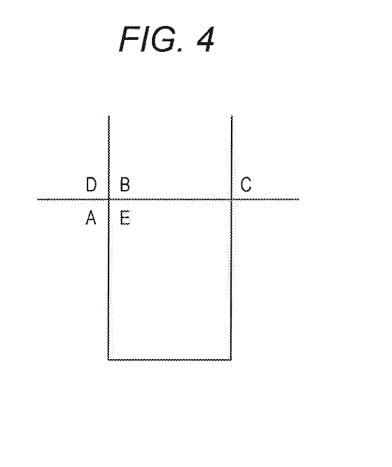

Each straight line as shown in FIG. 4 represents a border of motion compensation block. In FIG. 4, E denotes the motion compensation block which is to be coded, and A to D respectively denote motion compensation blocks adjacent to E which has already been coded.

Now, X=A, B, C, D, E, and the motion vector information with respect to X is defined as mvₓ.

First, using the motion vector information about the motion compensation blocks A, B, and C, the prediction motion vector information pmv_{E} for the motion compensation block B is generated by median operation as shown in expression (10) below.

[Numerical expression 10]

pmv_{E}=med(mv_{A},mv_{B},mv_{C}) (10)

When information about the motion compensation block C is unavailable due to reasons, e.g., it is at an end of image frame, information about the motion compensation block C is used instead.

Data mvd_{E} that is coded as motion vector information for the motion compensation block E in the image compression information is generated as shown in expression (11) below using pmv_{E}.

[Numerical expression 11]

mvd_{E}=mv_{E}−pmv_{E} (11)

In the actual processing, the processing is independently performed on each of the components in the horizontal direction and vertical direction of the motion vector information.

[Multi Reference Frame]

The AVC has so-called Multi-Reference Frame which is method not defined in a conventional image encoding method such as MPEG2 and H.263.

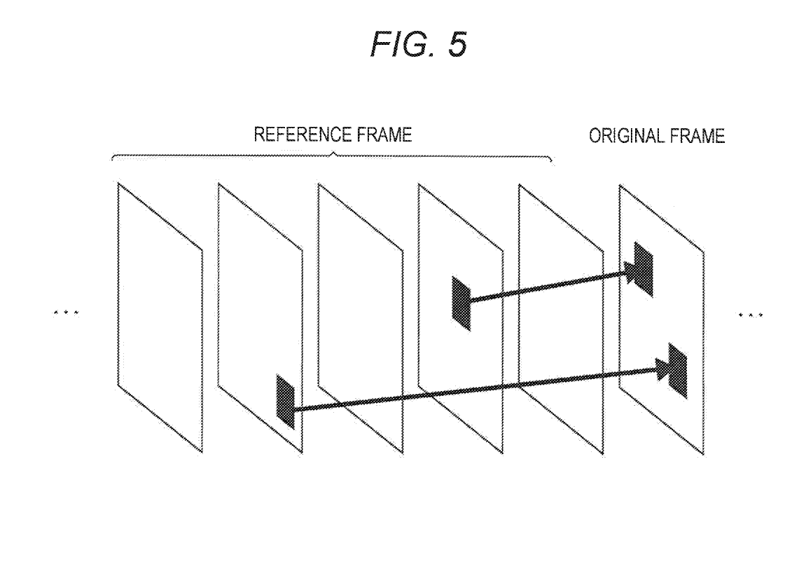

With reference to FIG. 5, multi reference frame defined in the AVC will be explained.

More specifically, in MPEG-2 and H.263, the motion prediction/compensation processing is performed by referring to only one reference frame stored in a frame memory in a case of P picture. In AVC, as shown in FIG. 5, multiple reference frames are stored to a memory, and for each macro block, a different memory can be looked up.

By the way, in MPEG2 and MPEG4, for example, motion exists like fade scene, but in a sequence where brightness changes, no encoding tool is prepared to absorb change of the brightness, and therefore, there is a problem in that the coding efficiency is reduced.

In order to solve such problem, in the AVC coding method, weight prediction processing can be performed (see Non-Patent Document 2). More specifically, in P picture, when Y₀ is a motion compensation prediction signal, a prediction signal is generated as shown in expression (12) below with weight coefficient W₀ and offset value being D.

W₀×Y₀+D (12)

In B picture, a prediction signal is generated as shown in expression (13) below while motion compensation prediction signals for List0 and List1 are Y₀ and Y₁, respectively, and weight coefficients are W₀ and W₁, and offset is D.

W₀×Y₀+W₁×Y₁+D (13)

In the AVC, in units of slices, whether or not this weight prediction is used or not can be designated.

The AVC has Explicit Mode for transmitting W and D to slice header as weight prediction and Implicit Mode for calculating W from the distance in a time axis in the picture and the reference picture.

In P picture, only Explicit Mode can be used.

In B picture, both of Explicit Mode and Implicit Mode can be used.

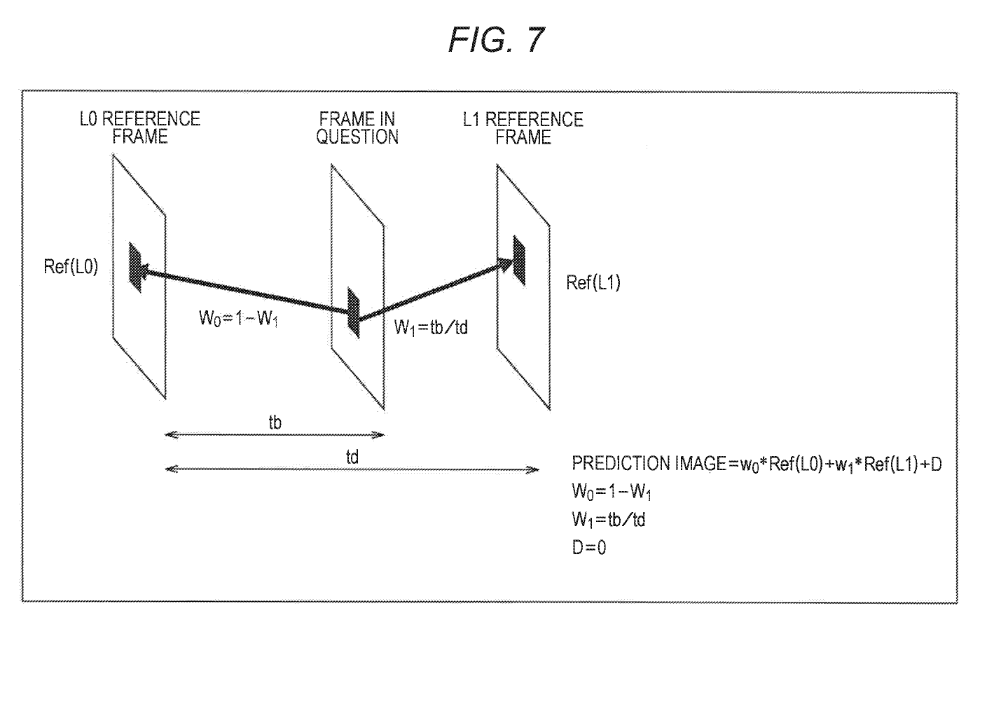

FIG. 7 illustrates a calculation method for calculating W and D in a case of Implicit Mode with B picture.

In the case of AVC, there is no information corresponding to tb and td which is time distance information, and therefore, POC (Picture Order Count) is used.

In the AVC, weight prediction can be applied in units of slices. Further, Non-Patent Document 2 also suggests a method for applying weight prediction in units of blocks (Intensity Compensation)

### [Selection of Motion Vector]

By the way, in order to cause the image coding device 100 as illustrated in FIG. 1 to obtain image compression information with a high degree of coding efficiency, it is important to use what kind of processing to select the motion vector and the macro block mode.

An example of processing includes a method implemented in reference software called JM (Joint Model) disclosed at http://iphome.hhi.de/suehring/tml/index.htm.

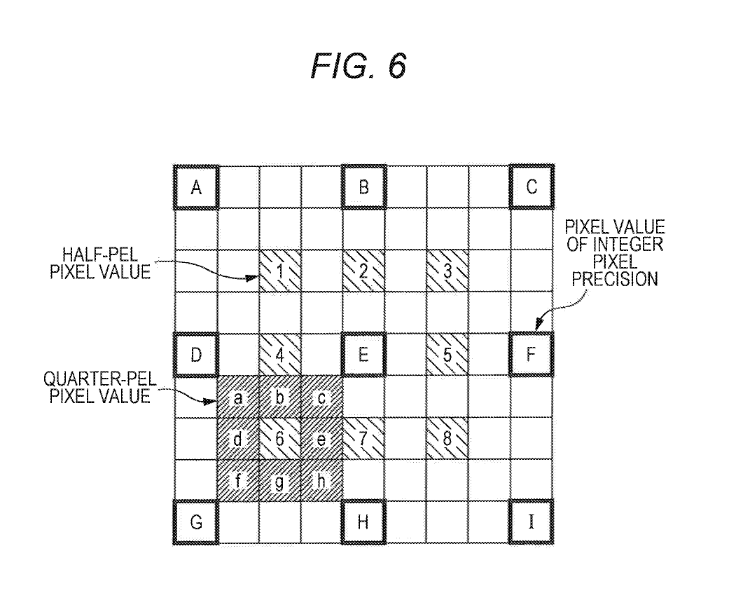

In the explanation below, the motion search method implemented in JM will be explained with reference to FIG. 6. In FIG. 6, A to I are integer-pel pixel values, 1 to 8 are pixel values of half-pel around E is a pixel value of half-pel around E, and a to h are pixel values of quarter-pel around 6.

In the first step, an integer-pel motion vector that makes cost function such as SAD (Sum of Absolute Difference) the minimum in a predetermined search range is derived. In the example of FIG. 6, suppose E is a pixel corresponding to the integer-pel motion vector.

In the second step, a pixel value that makes the cost function the minimum is derived from among E and 1 to 8 of half-pel around E, and this is adopted as the optimum motion vector of half-pd. In the example of FIG. 6, suppose that 6 is a pixel corresponding to the optimum motion vector of half-pel.

In the third step, a pixel value that makes the cost function the minimum is derived from among 6 and a to h of quarter-pel around 6, and this is adopted as the optimum motion vector of quarter-pel.

### [Selection of Prediction Mode]

In the explanation below, a mode determination method defined in JM will be described.

In the JM, two mode determination methods, i.e., High Complexity Mode and Low Complexity Mode, explained later can be selected. In both of them, the cost function value of each of the prediction modes is calculated, and a prediction mode that makes this the minimum is selected as an optimum mode for the block to macro block.

The cost function in the High Complexity Mode is calculated by the following expression (14).

Cost (ModeεΩ)=D+λ*R (14)

In this case, Ω denotes a total set of candidate modes for coding the block to the macro block, and D denotes difference energy between the decoded image and the input image when encoded with the prediction mode. λ denotes Lagrange multiplier given as a function of quantization parameter. R denotes the total amount of codes when coded in the mode including orthogonal transformation coefficient.

More specifically, the above parameters D and R are calculated in order to perform coding in the High Complexity Mode, and therefore, it is necessary to temporarily perform encode processing once in all the candidate modes, which requires higher amount of calculations.

The cost function in the Low Complexity Mode is shown in the expression (15) below.

Cost (ModeεΩ)D+QP2Quant (QP)*HeaderBit (15)

Unlike the case of the High Complexity Mode D denotes difference energy between the input image and the prediction image in this case. QP2Quant (QP) is given as a function of quantization parameter QP, and HeaderBit denotes the amount of codes about information which belongs to Header such as the motion vector and the mode not including orthogonal transformation coefficient.

More specifically, in the Low Complexity Mode, it is necessary to perform the prediction processing for each of the candidate modes, but a decoded image is not necessary, and therefore, it is not necessary to perform coding processing. For this reason, this can be achieved with an amount of calculation which is less than the High Complexity Mode.

### [Coding Unit]

By the way, making a macro block size of 16 pixel by 16 pixels is not suitable for a large image frame such as UHD (Ultra High Definition; 4000 pixel by 2000 pixels) which is a target of next-generation coding method.

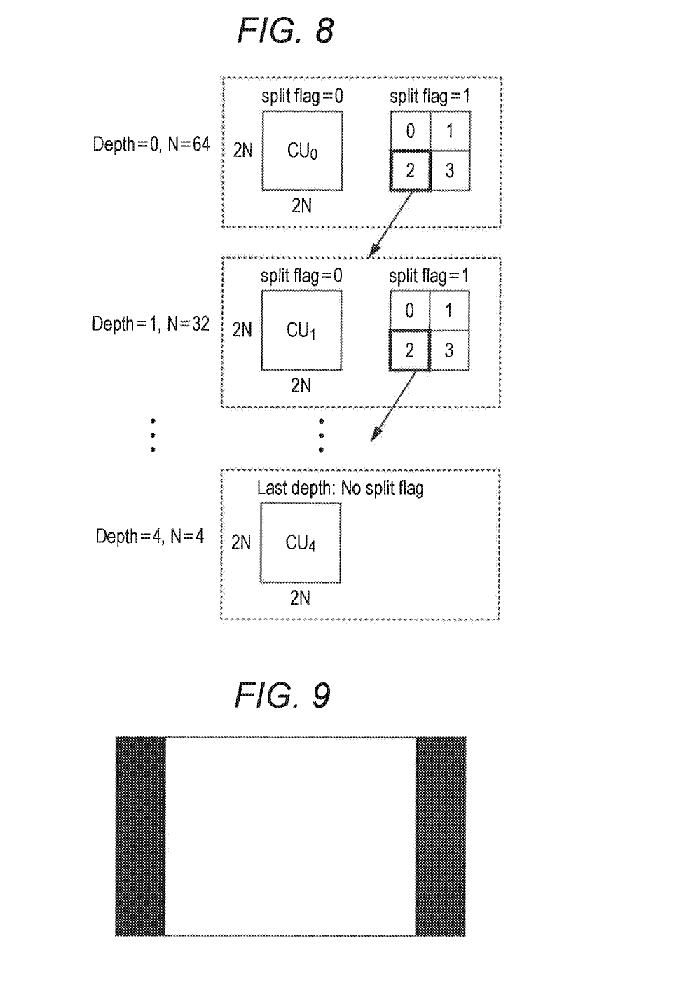

Therefore, in the AVC, as illustrated in FIG. 3, a hierarchical structure of macro blocks and sub-macro blocks is defined. For example, in HEVC (High Efficiency Video Coding), Coding Unit (CU) is defined as illustrated in FIG. 8

The CU is also referred to as a Coding Tree Block (CTB), and is a partial area of an image of picture unit, which is a counterpart of the macro block in AVC. In the latter, the size is fixed to 16 by 16 pixels, but in the former, the size is not fixed, and in each sequence, the size is designated in image compression information.

For example, in Sequence Parameter Set (SPS) included in the coded data which are to be output, the maximum size of the CU (LCU (Largest Coding Unit)) and the minimum size thereof ((SCU (Smallest Coding Unit)).

In each LCU, split-flag is 1 as long as the size is not less than the size of SCU, and accordingly, it is possible to divide a CU into CUs of a smaller size. In the example of FIG. 8, the size of the LCU is 128, and the maximum hierarchical depth is 5. When the value of split_flag is “1”, a CU of which size is 2N by 2N is divided into CUs of which size is N by N, which is a hierarchy in one level below.

Further, the CU is divided into Prediction Units (PUs), which are area s serving as processing unit of intra- or inter-prediction (partial area s of image of picture unit), and divided into Transform Units (TUs) which are area s serving as processing unit of orthogonal transformation (partial area s of image of picture unit). Currently, in the HEVC, in addition to 4 by 4 and 8 by 8, it is possible to use orthogonal transformation of 16 by 16 and 32 by 32.

In a case of coding method for defining CU and performing various kinds of processing by adopting the CU as a unit just like HEVC explained above, the macro block in the AVC is considered to correspond to the LCU. However, as illustrated in FIG. 8, the CU has the hierarchical structure, and therefore, the size of the LCU in the highest level in the hierarchy is generally set as, for example, 128 by 128 pixels, which is larger than the macro block of AVC.

In the explanation below, image units such as macro block, sub-macro block, CU, PU, and TU explained above may be simply referred to as “regions”. More specifically, in a case where processing unit of intra-prediction or inter-prediction is explained, “region” is any given image unit including these image units. Depending on the situation, “region” may include some of these image units, or may include image units other than those image units.

### [Reduction of Precision of Weight Prediction Due to the Contents of Image]

By the way, depending on an image, there is an image in which there is brightness change in a part of the image but there is no brightness change in a part of the remaining portion or the brightness change is not uniform there. For example, like an image with letter box and an image having pillar box as shown in FIG. 9, there are images in which a part of the image is constituted by an image where the brightness does not change such as black image (image painted in black) and the like. In addition, there are images such as those with frames and picture-in-picture.

In the case of AVC weight prediction, the weight prediction is uniformly applied to the entire image even with those images explained above. Therefore, in a portion where there is no brightness change, the prediction precision may be reduced, and the coding efficiency may be reduced.

Accordingly, the weight prediction unit 121 and the weight mode determination unit 122 control the mode (weight mode) of the weight prediction, for example, whether the weight prediction is performed or not using an image unit smaller than that of the AVC weight prediction.

### [Motion Prediction/Compensation Unit, Weight Prediction Unit, Weight Mode Determination Unit]

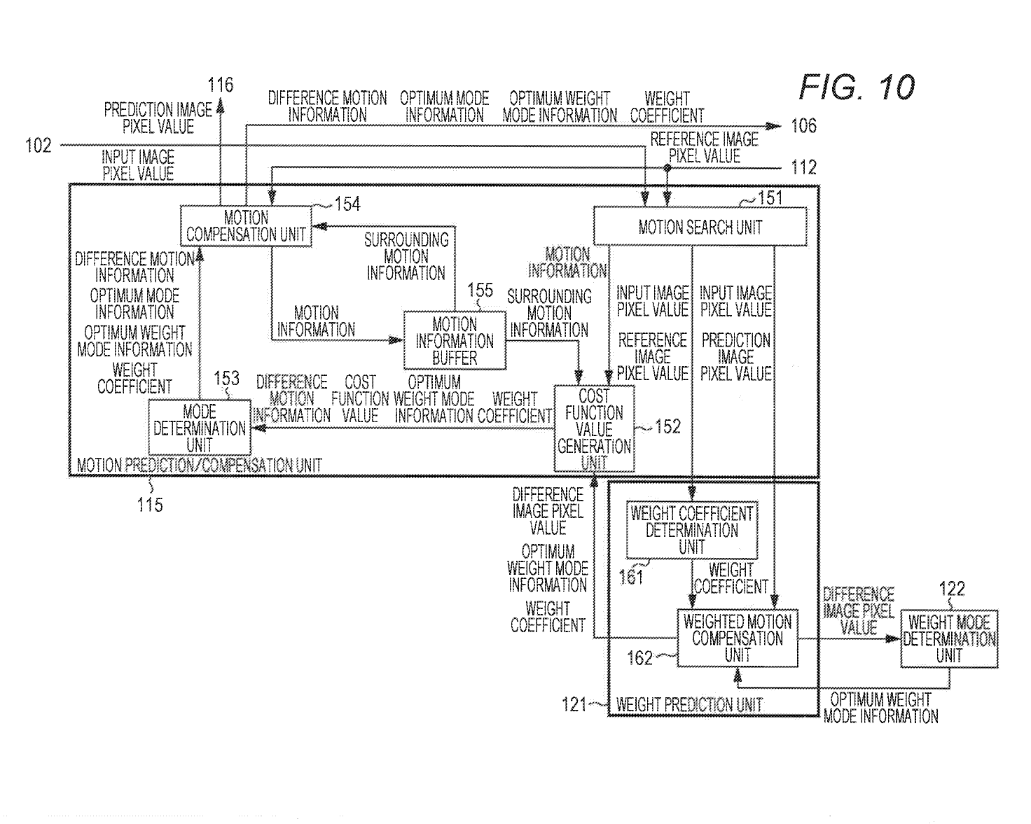

FIG. 10 is a block diagram for explaining an example of main configuration of the motion prediction/compensation unit 115, the weight prediction unit 121, and the weight mode determination unit 122 of FIG. 1.

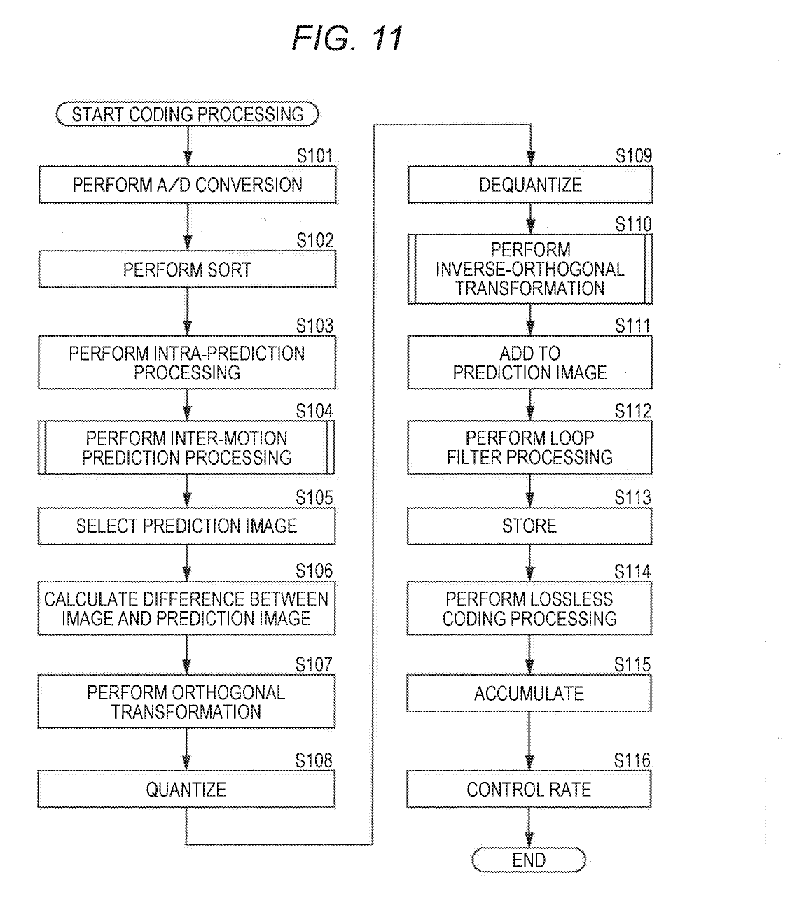

As shown in FIG. 11, the motion prediction/compensation unit 115 includes a motion search unit 151, a cost function value generation unit 152, a mode determination unit 153, a motion compensation unit 154, and a motion information buffer 155.

The weight prediction unit 121 includes a weight coefficient determination unit 161 and a weighted motion compensation unit 162.

The motion search unit 151 uses input image pixel values obtained from the screen sorting buffer 102 and reference image pixel values obtained from the frame memory 112 to perform motion search in each region of prediction processing unit in all the inter-prediction modes and obtain motion information, and providing the obtained information to the cost function value generation unit 152. The region of the prediction processing unit is an image unit smaller than slice which is processing unit of the AVC weight prediction at least, and the size thereof is different for each inter-prediction mode.

The motion search unit 151 provides the weight coefficient determination unit 161 of the weight prediction unit 121 with the input image pixel value and the reference image pixel value used for the motion search in each inter-prediction mode.

Further, the motion search unit 151 performs motion compensation not using weights using the motion information in each inter-prediction mode derived in all the inter-prediction modes (also referred to as motion compensation in weight OFF state), and generates prediction images in weight prediction OFF state. More specifically, the motion search unit 151 generates a prediction image in weight prediction OFF state for each region of prediction processing unit. The motion search unit 151 provides the prediction image pixel values as well as input image pixel values to the weighted motion compensation unit 162.

The weight coefficient determination unit 161 of the weight prediction unit 121 determines weight coefficients of L0 and L1 (W, D, and the like). More specifically, weight coefficient determination unit 161 determines weight coefficients of L0 and L1 on the basis of the input image pixel values and the reference image pixel values provided from the motion search unit 151 in all the inter-prediction modes. That is, the weight coefficient determination unit 161 determines weight coefficients for each region of prediction processing unit. The weight coefficient determination unit 161 provides the weight coefficients as well as the input image and the reference image to the weighted motion compensation unit 162.

The weighted motion compensation unit 162 performs the motion compensation using the weights for each region of prediction processing unit (also referred to as motion compensation in weight ON state). The weighted motion compensation unit 162 generates difference image between the input image and the prediction image in all the prediction modes and all the weight modes (modes concerning weights), and provides the difference image pixel values to the weight mode determination unit 122.

More specifically, the weighted motion compensation unit 162 uses the weight coefficients and the images provided from the weight coefficient determination unit 161 to perform the motion compensation in weight ON state in all the inter-prediction modes, and generates prediction images in weight ON state. More specifically, the weighted motion compensation unit 162 generates a prediction image in weight ON state for each region of prediction processing unit. Then, the weighted motion compensation unit 162 generates difference image between the input image and the prediction image in weight ON state (difference image in weight ON state) for each region of prediction processing unit.

The weighted motion compensation unit 162 generates difference image between the input image and the prediction image in weight OFF state (difference image in weight OFF state) provided from the motion search unit 151 in all the inter-prediction modes. More specifically, the weighted motion compensation unit 162 generates a difference image in weight OFF state for each region of prediction processing unit.

The weighted motion compensation unit 162 provides the weight mode determination unit 122 with the difference image in weight ON state and the difference image in weight OFF state for each region of prediction processing unit in all the inter-prediction modes.

The weighted motion compensation unit 162 provides the cost function value generation unit 152 of the motion prediction/compensation unit 115 with information about the weight mode indicated by the optimum weight mode information provided from the weight mode determination unit 122 for each region of prediction processing unit.

More specifically, in all the inter-prediction modes, the weighted motion compensation unit 162 provides the cost function value generation unit 152 with the optimum weight mode information provided from the weight mode determination unit 122, the difference image pixel value in the weight mode (the difference image in weight ON state or the difference image in weight OFF state), and the weight coefficients in the weight mode (in the mode of weight OFF, the weight coefficient is not necessary).

The weight mode determination unit 122 compares the difference image pixel values of multiple weight modes with each other for each region of prediction processing unit, and determines the optimum weight mode.

More specifically, the weight mode determination unit 122 compares the difference image pixel values in weight ON state and the difference image pixel values in weight OFF state provided from the weighted motion compensation unit 162. The smaller the difference image pixel value is (i.e., difference from the input image is smaller), the higher the prediction precision is Therefore, the weight mode determination unit 122 determines that the weight mode corresponding to the difference image of which pixel value is the smallest is the optimum weight mode. More specifically, the weight mode determination unit 122 determines that one of the two modes in weight ON and weight OFF states of which prediction precision is higher (i.e., difference from the input image is smaller) is the optimum weight mode.

The weight mode determination unit 122 provides the weighted motion compensation unit 162 with the determination result as optimum weight mode information indicating the weight mode selected as being the optimum mode.

The weight mode determination unit 122 determines such optimum weight mode in all the inter-prediction modes.

The cost function value generation unit 152 calculates the cost function values of the optimum weight modes in all the inter-prediction modes for each region of prediction processing unit.

More specifically, the cost function value generation unit 152 calculates the cost function value of the difference image pixel value in the optimum weight mode in each inter-prediction, mod provided from the weighted motion compensation unit 162. The cost function value generation unit 152 provides the mode determination unit 153 with the calculated cost function value as well as the optimum weight mode information and the weight coefficient (in the mode of weight OFF, the weight coefficient is not necessary).

The cost function value generation unit 152 obtains the surrounding motion information from the motion information buffer 155 in all the inter-prediction modes for each region of prediction processing unit, and calculates difference between the motion information provided from the motion search unit 151 and the surrounding motion information (difference motion information). The cost function value generation unit 152 provides the mode determination unit 153 with the difference motion information in each inter-prediction mode calculated.

The mode determination unit 153 determines, for each region of prediction processing unit, that the prediction mode making the cost function value the minimum is the optimum inter-prediction mode for the processing target region.

More specifically, the mode determination unit 153 determines that the inter-prediction mode of which cost function value provided from the cost function value generation unit 152 is the minimum is the optimum inter-prediction mode of the region. The mode determination unit 153 provides the motion compensation unit 154 with the optimum mode information indicating the optimum inter-prediction mode as well as the difference motion information, the optimum weight mode information, and the weight coefficient (in the mode of weight OFF, the weight coefficient is not necessary) of the optimum inter-prediction mode.

The motion compensation unit 154 performs motion compensation in the optimum weight mode in the optimum inter-prediction mode for each region of prediction processing unit, and generates a prediction image.

More specifically, the motion compensation unit 154 obtains various kinds of information such as the optimum mode information, the difference motion information, the optimum weight mode information, and the weight coefficient from the mode determination unit 153. The motion compensation unit 154 obtains the surrounding motion information from the motion information buffer 155 in the optimum inter-prediction mode indicated by the optimum mode information.

The motion compensation unit 154 uses the surrounding motion information and the difference motion information to generate the motion information in the optimum inter-prediction mode. The motion compensation unit 154 uses the motion information to obtain the reference image pixel values from the frame memory 112 in the optimum inter-prediction mode indicated by the optimum mode information.

The motion compensation unit 154 uses the reference image and the weight coefficient (in the mode of weight OFF, the weight coefficient is not necessary) to perform motion compensation in the optimum weight mode for each region of prediction processing unit, and generates a prediction image. The motion compensation unit 154 provides the prediction image selection unit 116 with the generated prediction image pixel value for each region of prediction processing unit, and causes the calculation unit 103 to decrease the value from the input image or causes the calculation unit 110 to add the value to the difference image.

The motion compensation unit 154 provides the lossless coding unit 106 with various kinds of information used for motion search and motion compensation, e.g., the difference motion information, the optimum mode information, the optimum weight mode information, and the weight coefficient (in the mode of weight OFF, the weight coefficient is not necessary) for each region of prediction processing unit, and causes the lossless coding unit 106 to encode the information. In Explicit mode, the weight coefficient is not encoded, either.

As described above, the weight mode determination unit 122 generates the optimum weight mode information indicating the optimum weight mode for each image unit smaller than slice, the weighted motion compensation unit 162 of the weight prediction unit 121 provides the motion prediction/compensation unit 115 with the optimum weight mode information for each image unit smaller than slice, the motion prediction/compensation unit 115 generates a prediction image by performing the motion compensation in the optimum weight mode for each image unit smaller than slice, and transmit the optimum weight mode information to the decoding side.

Therefore, the image coding device 100 can control the weight prediction in each smaller region. More specifically, the image coding device 100 can control whether the weight prediction is performed or not in each smaller region. Therefore, even when the image coding device 100 encodes, for example, an image in which brightness change is not uniform over the entire image as shown in FIG. 9, the image coding device 100 can perform the weight prediction only in a portion of the entire image where there is brightness change, and therefore, this can suppress the effect given to the weight coefficient by a portion in which there is no brightness change, and can suppress the reduction of the prediction precision of the weight prediction. Therefore, the image coding device 100 can improve the coding efficiency.

### [Flow of Coding Processing]

Subsequently, the flow of each processing executed by the image coding device 100 explained above will be explained. First, an example of flow of coding processing will be explained with reference to the flowchart of FIG. 11.

In step S101, the A/D conversion unit 101 performs A/D conversion on a received image. In step S102, the screen sorting buffer 102 stores images that have been subjected to the A/D conversion, and sorts them from the order in which pictures are displayed into the order in which they are encoded.

In step S103, the intra-prediction unit 114 performs the intra-prediction processing. In step S104, the motion prediction/compensation unit 115, the weight prediction unit 121, and the motion vector precision determination unit 122 perform inter-motion prediction processing. In step S105, the prediction image selection unit 116 selects one of the prediction image generated by intra-prediction and prediction image generated by inter-prediction.

In step S106, the calculation unit 103 calculates difference between the image sorted in the processing in step S102 and the prediction image selected in the processing in step S105 (generate difference image). The amount of data in the generated difference image is less than the original image. Therefore, the amount of data can be compressed as compared with a case where an image is compressed as it is.

In step S107, the orthogonal transformation unit 104 performs orthogonal transformation on difference image generated by the processing in step S106. More specifically, orthogonal transformation such as discrete cosine transform and Karhunen-Loeve conversion and like is performed and, orthogonal transformation coefficients are output. In step S108, the quantization unit 105 quantizes the orthogonal transformation coefficients obtained in the processing in step S107.

As a result of the processing in step S108, the quantized difference image is locally decoded as follows. More specifically, in step S109, the inverse-quantization unit 108 dequantizes the quantized orthogonal transformation coefficient generated in the processing in step S108 (which may also referred to as quantization coefficients) according to the characteristics corresponding to the characteristics of the quantization unit 105. In step S110, the inverse-orthogonal transformation unit 109 performs inverse-orthogonal transformation on the orthogonal transformation coefficients obtained the processing in step S109 according to the characteristics corresponding to the characteristics of the orthogonal transformation unit 104. Thus, the difference image is restored.

In step S111, the calculation unit 110 adds the prediction image selected in step S105 to the difference image generated in step S110, and generates the locally decoded image (reconfigured image). In step S112, as necessary, the loop filter 111 applies loop filter processing including deblock filter processing, adaptive loop filter processing, and the like, to the reconfigured image obtained in the processing in step S111, thus generating decoded image.

In step S113, the frame memory 112 stores the decoded image generated in the processing of step S112 or the reconfigured image generated by the processing of step S111.

In step S114, the lossless coding unit 106 encodes the orthogonal transformation coefficients quantized in the processing in step S108. More specifically, lossless coding such as variable length coding and arithmetic coding is applied to the difference image. It should be noted that the lossless coding unit 106 encodes information about prediction and information about quantization, and adds the information to the bit stream.

In step S115, the accumulation buffer 107 accumulates the bit stream obtained in the processing in step S114. The coded data accumulated in the accumulation buffer 107 are read as necessary, and transmitted to the decoding side via the transmission path and the recording medium.

In step S116, the rate control unit 117 controls the rate of the quantization operation of the quantization unit 105 so as not to cause overflow and underflow, on the basis of the amount of codes of the coded data accumulated in the accumulation buffer 107 (the amount of codes generated) in the processing in step S115.

When the processing in step S116 is finished, the coding processing is terminated.

### [Flow of Inter-Motion Prediction Processing]

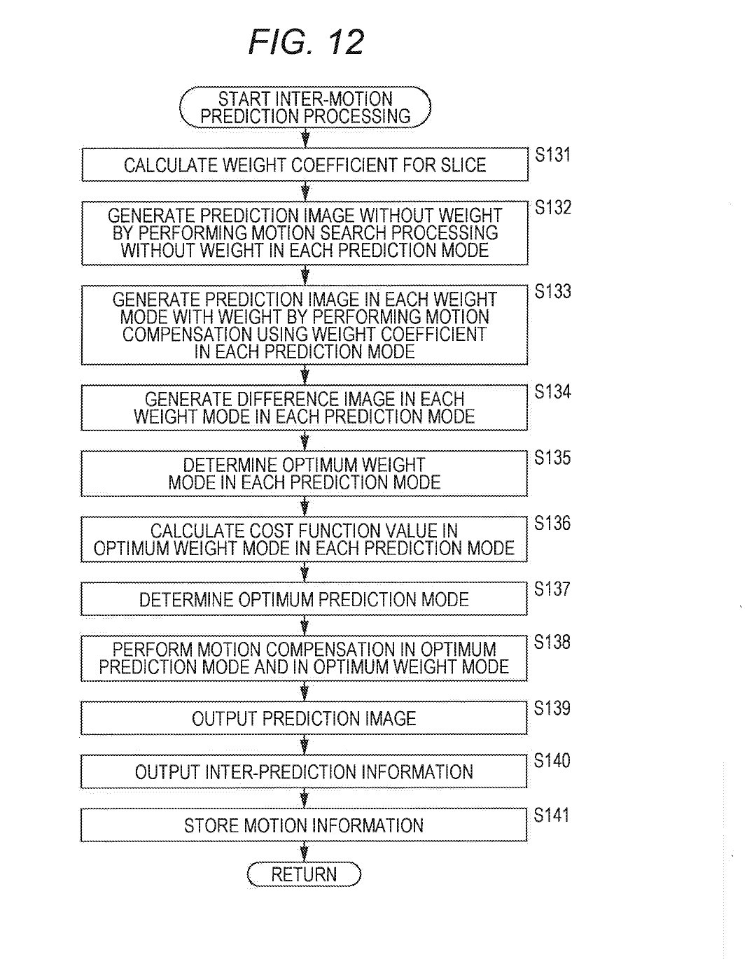

Subsequently, an example of flow of the inter-motion prediction processing executed in step S104 of FIG. 11 will be explained with reference to the flowchart of FIG. 12.

In step S131, the weight coefficient determination unit 161 determines the weight coefficient for the slice. In step S132, in each inter-prediction mode, the motion search unit 151 performs motion search without weight, and generates a prediction image in a mode without weight. In step S133, the weighted motion compensation unit 162 performs the motion compensation using the weight coefficient calculated in step S131 in each inter-prediction mode, and generates a prediction image in each weight mode with weight.

In step S134, the weighted motion compensation unit 162 generates a difference image in each weight mode in each inter-prediction mode. In step S135, the weight mode determination unit 122 uses the difference image in each weight mode generated in step S134 to determine the optimum weight mode in each inter-prediction mode. In step S136, the cost function value generation unit 152 calculates the cost function value in the optimum weight mode in each inter-prediction mode. In step S137, the mode determination unit 153 determines the optimum inter-prediction mode on the basis of cost function value calculated in step S136. In step S138, the motion compensation unit 154 performs motion compensation in the optimum weight mode in the optimum inter-prediction mode, and generates a prediction image.

In step S139, the motion compensation unit 154 outputs the prediction image generated in step S138 to the prediction image selection unit 116. In step S140, the motion compensation unit 154 outputs the inter-prediction information such as the difference motion information, the optimum mode information, the optimum weight mode information, and the weight coefficient. When the optimum weight mode is weight OFF mode and Explicit mode, the output of the weight coefficient is omitted.

In step S141, the motion information buffer 155 stores the motion information of the region provided from the motion compensation unit 154.

When the motion information is stored, the motion information buffer 155 terminates the inter-motion prediction processing, and the processing in FIG. 11 is performed back again.

By performing each processing as described above, the image coding device 100 can control the weight prediction in each smaller region, and can suppress reduction of the prediction precision of the weight prediction, and can improve the coding efficiency.

### 2. Second Embodiment

### Image Decoding Device

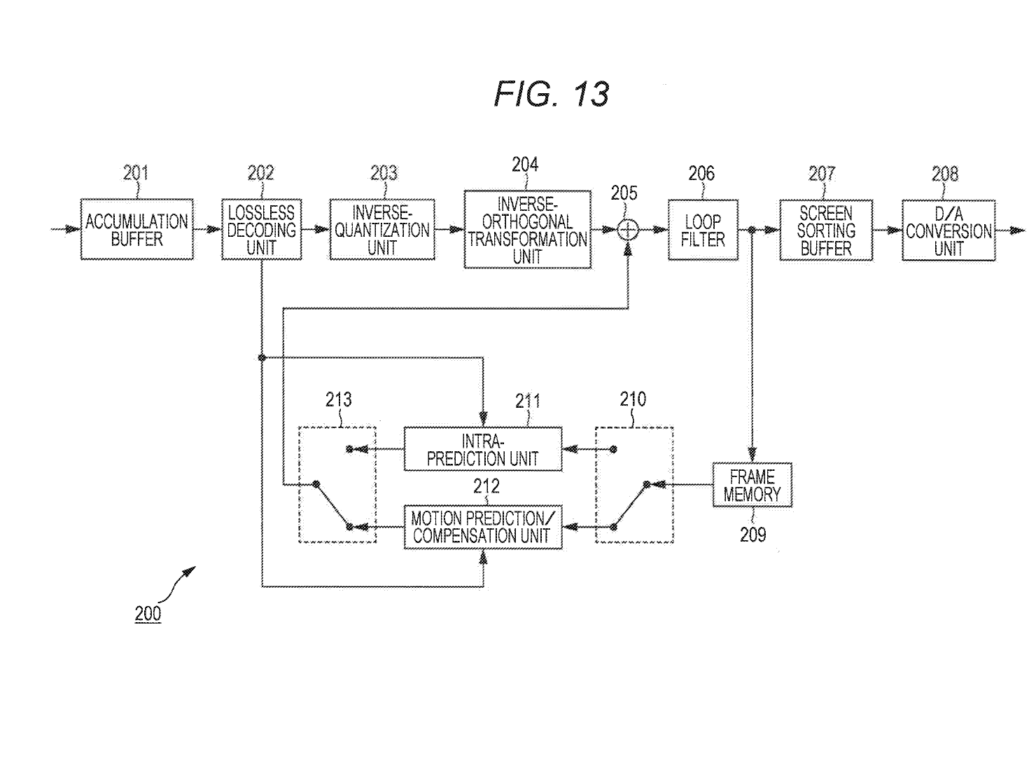

Subsequently, decoding of the coded data which are encoded as described above will be explained. FIG. 13 is a block diagram for explaining an example of main configuration of an image decoding device corresponding to the image coding device 100 of FIG. 1.

As illustrated in FIG. 13, an image decoding device 200 decodes coded data generated by the image coding device 100 in accordance with decoding method corresponding to the encoding method of the image coding device 100.

As illustrated in FIG. 13, the image decoding device 200 includes an accumulation buffer 201, a lossless decoding unit 202, an inverse-quantization unit 203, an inverse-orthogonal transformation unit 204, a calculation unit 205, a loop filter 206, a screen sorting buffer 207, and a D/A conversion unit 208. Further, the image decoding device 200 includes a frame memory 209, a selection unit 210, an intra-prediction unit 211, a motion prediction/compensation unit 212, and a selection unit 213.

The accumulation buffer 201 accumulates received coded data, and provides the coded data to the lossless decoding unit 202 with predetermined timing. The lossless decoding unit 202 decodes information, which is provided by the accumulation buffer 201 and encoded by the lossless coding unit 106 of FIG. 1, in accordance with the method corresponding to the encoding method of the lossless coding unit 106. The lossless decoding unit 202 provides the inverse-quantization unit 203 with quantized coefficient data of the difference image obtained as a result of decoding.

The lossless decoding unit 202 determines whether the intra-prediction mode or the inter-prediction mode is selected as the optimum prediction mode, and provides information about the optimum prediction mode to the intra-prediction unit 211 or the motion prediction/compensation unit 212 of which mode is determined to be selected. More specifically, for example, when the image coding device 100 selects the intra-prediction mode as the optimum prediction mode, intra-prediction information which is information about the optimum prediction mode is provided to the intra-prediction unit 211. For example, when the image coding device 100 selects the inter-prediction mode as the optimum prediction mode, inter-prediction information which is information about the optimum prediction mode is provided to the motion prediction/compensation unit 212.

The inverse-quantization unit 203 quantizes the quantized coefficient data, which are obtained from decoding process of the lossless decoding unit 202, in accordance with the method corresponding to the quantization method of the quantization unit 105 of the FIG. 1, and provides the obtained coefficient data to the inverse-orthogonal transformation unit 204. The inverse-orthogonal transformation unit 204 performs inverse-orthogonal transformation on the coefficient data, which are provided from the inverse-quantization unit 203, in accordance with the method corresponding to the orthogonal transformation method of the orthogonal transformation unit 104 of the FIG. 1. As a result of this inverse-orthogonal transformation processing, the inverse-orthogonal transformation unit 204 obtains difference image corresponding to difference image before the orthogonal transformation is performed by the image coding device 100.

The difference image obtained from the inverse-orthogonal transformation is provided to the calculation unit 205. The calculation unit 205 receives a prediction image from the intra-prediction unit 211 or the motion prediction/compensation unit 212 via the selection unit 213.

The calculation unit 205 adds the difference image and the prediction image, and obtains reconfigured image corresponding to image before the prediction image is subtracted by the calculation unit 103 of the image coding device 100. The calculation unit 205 provides the reconfigured image to the loop filter 206.

As necessary, the loop filter 206 applies loop filter processing including deblock filter processing, adaptive loop filter processing, and the like, to the provided reconfigured image as necessary, and generates a decoded image. For example, the loop filter 206 applies deblock filter processing to the reconfigured image to remove block noise. For example, the loop filter 206 applies loop filter processing to the deblock filter processing result (reconfigured image from which only the block noise has been removed) using Wiener Filter, thus improving the image equality.

It should be noted that the type of filter processing performed by the loop filter 206 may be any type, and filter processing other than what has been explained above may be performed. The loop filter 206 may also apply applies deblock filter processing using filter coefficients provided from the image coding device 100 of FIG. 1.

The loop filter 206 provides the decoded image which is the filter processing result to the screen sorting buffer 207 and the frame memory 209. It should be noted that the filter processing performed by the loop filter 206 may be omitted. More specifically, the output of the calculation unit 205 may not be filtered, and may be stored to the frame memory 209. For example, the intra-prediction unit 211 uses the pixel values of the pixels included in the image as the pixel values of the surrounding pixels.

The screen sorting buffer 207 sorts the decoded images provided. More specifically, the order of frames sorted for the order of encoding by the screen sorting buffer 102 of FIG. 1 is sorted into the original order for display. The D/A conversion unit 208 performs D/A conversion on a decoded image provided from the screen sorting buffer 207, outputs the image to a display, not shown, and causes the display to show the image.

The frame memory 209 stores the reconfigured image and the decoded images provided. The frame memory 209 provides the stored reconfigured image and the decoded image to the intra-prediction unit 211 and the motion prediction/compensation unit 212 with predetermined timing or on the basis of external request such as the intra-prediction unit 211 and the motion prediction/compensation unit 212.

The intra-prediction unit 211 basically performs the same processing as the intra-prediction unit 114 of FIG. 1. However, the intra-prediction unit 211 performs intra-prediction only on the region where the prediction image is generated by intra-prediction during coding.

The motion prediction/compensation unit 212 performs inter-motion prediction processing on the basis of inter-prediction information provided from the lossless decoding unit 202, and generates a prediction image. It should be noted that the motion prediction/compensation unit 212 performs inter-motion prediction processing only on the region where inter-prediction is performed during coding, on the basis of inter-prediction information provided from the lossless decoding unit 202, and generates a prediction image. The motion prediction/compensation unit 212 performs inter-motion prediction processing in the optimum inter-prediction mode, and in the optimum weight mode for each region of prediction processing unit, on the basis of the optimum mode information and the optimum weight mode information included in the inter-prediction information provided from the lossless decoding unit 202.

The motion prediction/compensation unit 212 provides the prediction image to the calculation unit. 205 via the selection unit 213 for each region of prediction processing unit.

It should be noted that the region of prediction processing unit is the same as that of the image coding device 100, and is at least an image unit smaller than the slice which is the control unit with which whether or not the weight prediction of the AVC is performed is controlled.

The selection unit 213 provides the prediction image provided from the intra-prediction unit 211 or the prediction image provided from the motion prediction/compensation unit 212 to the calculation unit 205.

### [Motion Prediction/Compensation Unit]

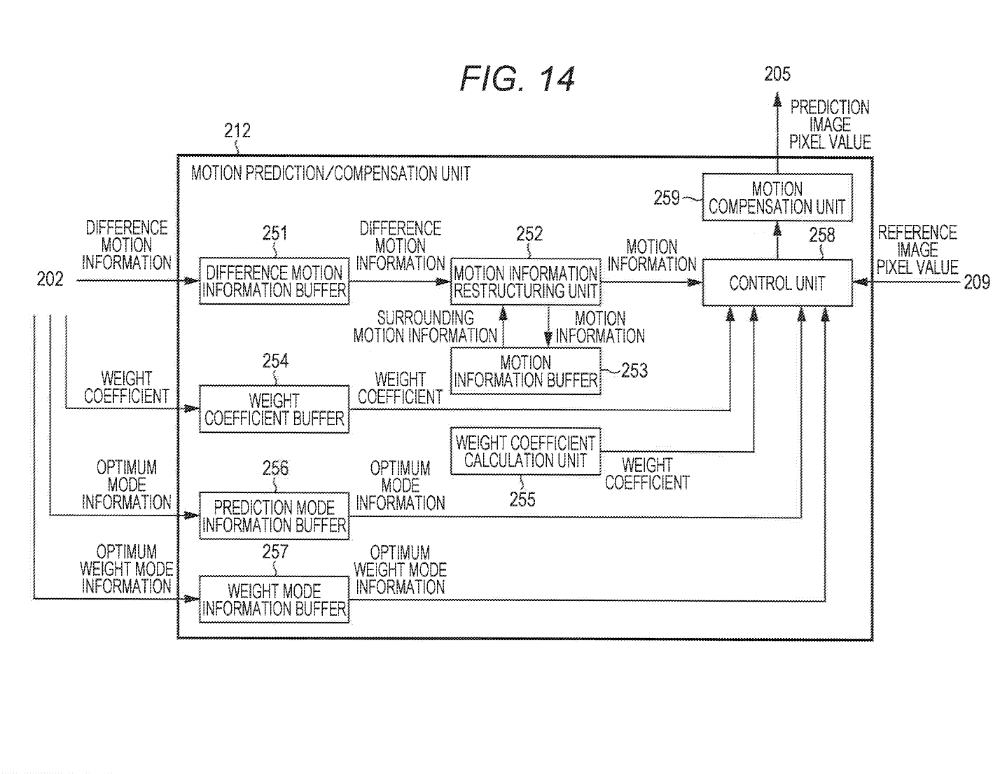

FIG. 14 is a block diagram illustrating an example of main configuration of the motion prediction/compensation unit 212 as shown in FIG. 13.

As shown in FIG. 14, the motion prediction/compensation unit 212 includes a difference motion information buffer 251, a motion information restructuring unit 252, a motion information buffer 253, a weight coefficient buffer 254, a weight coefficient calculation unit 255, a prediction mode information buffer 256, a weight mode information buffer 257, control unit 258, and a motion compensation unit 259.

The difference motion information buffer 251 stores the difference motion information extracted from the bit stream, which is provided from the lossless decoding unit 202. The difference motion information buffer 252 provides the stored difference motion information to the motion information restructuring unit 252 with predetermined timing or on the basis of external request.

When the motion information restructuring unit 252 obtains difference motion information from the difference motion information buffer 251, the motion information restructuring unit 252 obtains surrounding motion information about the region from the motion information buffer 253. The motion information restructuring unit 252 uses the motion information to restructure the motion information about the region. The motion information restructuring unit 252 provides the restructured motion information to the control unit 258 and the motion information buffer 253.

The motion information buffer 253 stores the motion information provided from the motion information restructuring unit 252. The motion information buffer 253 provides the stored motion information as the surrounding motion information to the motion information restructuring unit 252.

The weight coefficient buffer 254 stores the weight coefficient extracted from the bit stream, which is provided from the lossless decoding unit 202. The weight coefficient buffer 254 provides the stored weight coefficient to the control unit 258 with predetermined timing or on the basis of external request.

The weight coefficient calculation unit 255 calculates the weight coefficient, and provides the calculated weight coefficient to the control unit 258.

The prediction mode information buffer 256 stores the optimum mode information extracted from the bit stream, which is provided from the lossless decoding unit 202. The prediction mode information buffer 256 provides the stored optimum mode information to the control unit 258 with predetermined timing or on the basis of external request.

The weight mode information buffer 257 stores the optimum weight mode information extracted from the bit stream, which is provided from the lossless decoding unit 202. The weight mode information buffer 257 provides the stored optimum weight mode information to the control unit 258 with predetermined timing or on the basis of external request.

When the optimum inter-prediction mode is Explicit mode for transmitting the weight coefficient (W, D, and the like), the control unit 258 obtains the weight coefficient from the weight coefficient buffer 254. When the optimum inter-prediction mode is Inplicit mode for not transmitting the weight coefficient (W, D, and the like), the control unit 258 causes the weight coefficient calculation unit 255 to calculate the weight coefficient and obtains the weight coefficient.

The control unit 258 obtains the optimum mode information from the prediction mode information buffer 256. The control unit 258 obtains the optimum weight mode information from the weight mode information buffer 257. Further, the control unit 252 obtains the motion information from the motion information restructuring unit 252. The control unit 258 obtains the reference image pixel value from the frame memory 209.

The control unit 258 provides the motion compensation unit 259 with information required for motion compensation in the optimum inter-prediction mode and in the optimum weight mode.

The motion compensation unit 259 uses various kinds of information provided from the control unit 258 to perform the motion compensation of the region in the optimum inter-prediction mode and in the optimum weight mode.

As described above, on the basis of the information transmitted from the image coding device 100, the motion prediction/compensation unit 212 performs motion compensation in accordance with motion prediction/compensation processing performed by the image coding device 100 while controlling weight prediction, and generates a prediction image.

Therefore, the image decoding device 200 can perform motion compensation using motion information generated from weight prediction controlled in each smaller region. More specifically, the image decoding device 200 can perform motion compensation using motion information generated from weight prediction in which whether the weight prediction is performed or not is controlled in each smaller region.

Therefore, for example, the image decoding device 200 encodes an image in which the brightness change is not uniform in the entire image as shown in FIG. 9, the image decoding device 200 can perform motion compensation using motion information in which weight prediction is performed only in a portion of the entire image where there is brightness change. Therefore, the image decoding device 200 can achieve suppression of reduction of the prediction precision of the weight prediction which occurs with the image coding device 100, and can achieve improvement of the coding efficiency.

### [Flow of Decoding Processing]

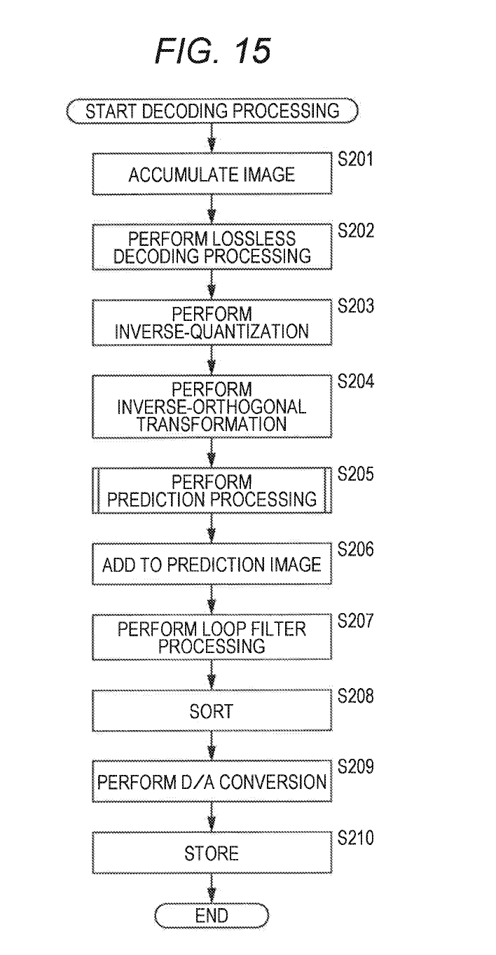

Subsequently, the flow of each processing executed by the image decoding device 200 explained above will be explained. First, an example of flow of decoding processing will be explained with reference to the flowchart of FIG. 15.

When the decoding processing is started, the accumulation buffer 201 accumulates a received bit stream in step S201. In step S202, the lossless decoding unit 202 decodes the bit stream (encoded difference image information) provided from the accumulation buffer 201.

At this occasion, various kinds of information other than the difference image information included in the bit stream, such as the intra-prediction information and the inter-prediction information, are also decoded.

In step S203, the inverse-quantization unit 203 dequantizes the quantized orthogonal transformation coefficients obtained in the processing in step S202. In step S204, the inverse-orthogonal transformation unit 204 performs inverse-orthogonal transformation on the orthogonal transformation coefficients dequantized in step S203.

In step S205, the intra-prediction unit 211 or the motion prediction/compensation unit 212 performs prediction processing using the provided information. In step S206, the calculation unit 205 adds the prediction image generated in step S205 to the difference image information obtained from the inverse-orthogonal transformation in step S204. Thus, the reconfigured image is generated.

In step S207, as necessary, the loop filter 206 applies loop filter processing including deblock filter processing, adaptive loop filter processing, and the like, to the reconfigured image obtained in step S206.

In step S208, the screen sorting buffer 207 sorts decoded images generated from filtering processing in step S207. More specifically, the order of frames sorted for encoding by the screen sorting buffer 102 of the image coding device 100 is sorted into the original order for display.

In step S209, the D/A conversion unit 208 performs D/A conversion on the decoded images in which frames are sorted. The decoded images are output to a display, not shown, and are displayed.

In step S210, the frame memory 209 stores the decoded images obtained from the filter processing in step S207. The decoded image is used as a reference image in the inter-prediction processing.

When the processing in step S210 is finished, the decoding processing is terminated.

### [Flow of Prediction Processing]

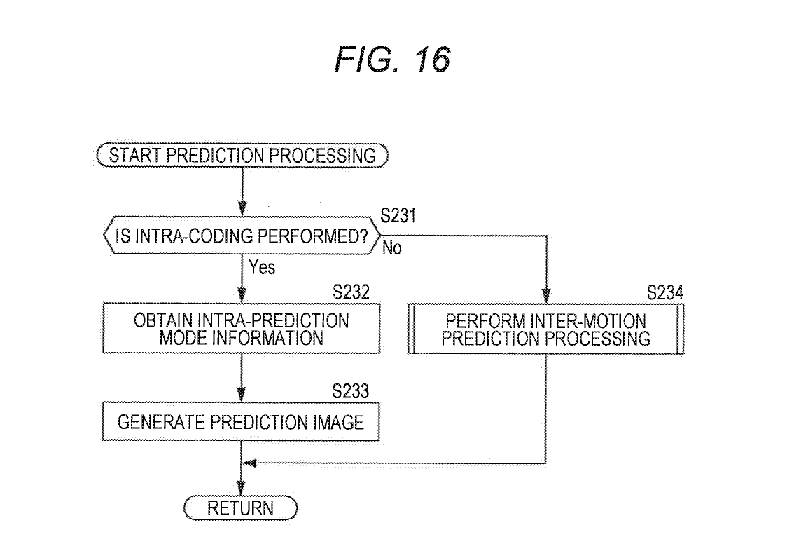

Subsequently, an example of flow of the prediction processing executed in step S205 of FIG. 15 will be explained with reference to the flowchart of FIG. 16.

When the prediction processing is started, the intra-prediction unit 211 determines whether or not intra-prediction is performed in processing target region during coding, on the basis of the intra-prediction information or the inter-prediction information provided from the lossless decoding unit 202 in step S231. When the intra-prediction unit 211 determines that the intra-prediction is performed, the intra-prediction unit 211 subsequently performs the processing in step S232.

In this case, the intra-prediction unit 211 obtains the intra-prediction mode information in step S232, and generates a prediction image by intra-prediction in step S233. When the prediction image is generated, the intra-prediction unit 211 terminates the prediction processing, and returns back to the processing in FIG. 15.

When the intra-prediction unit 211 determines that the region is a region where the inter-prediction is performed in step S231, the intra-prediction unit 211 subsequently performs to the processing in step S234. In step S234, the motion prediction/compensation unit 212 performs the inter-motion prediction processing. When the inter-motion prediction processing is finished, the motion prediction/compensation unit 212 terminates the prediction processing, and returns back to the processing in FIG. 15.

### [Flow of Inter-Motion Prediction Processing]

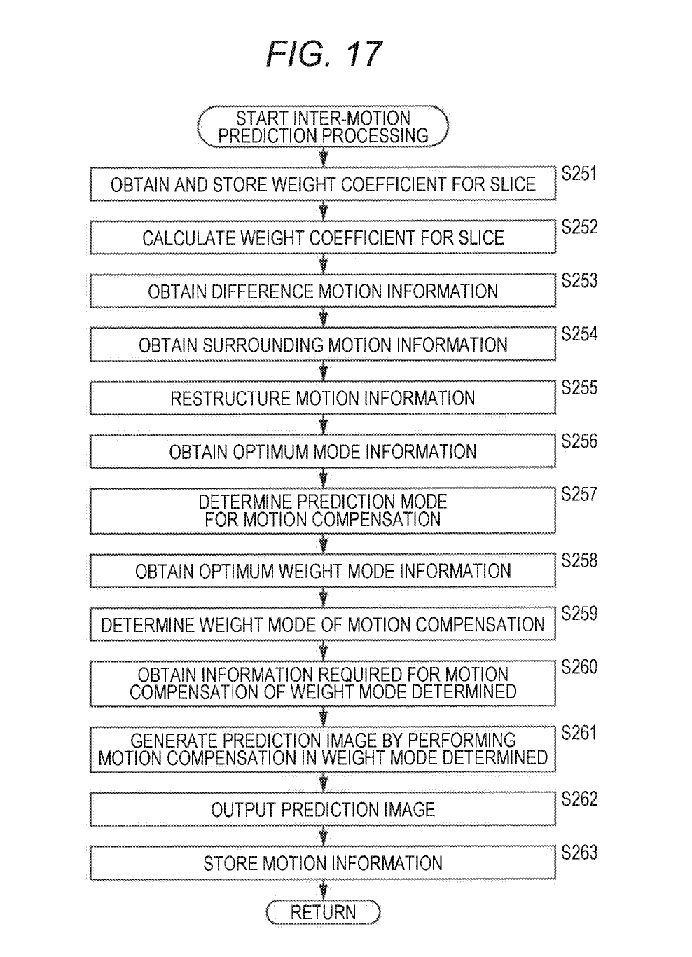

Subsequently, an example of flow of the inter-motion prediction processing executed in step S234 of FIG. 16 will be explained with reference to the flowchart of FIG. 17.

When the inter-motion prediction processing is started, the weight coefficient buffer 254 obtains and stores the weight coefficient for the slice for Explicit mode in step S251. In step S252, the weight coefficient calculation unit 255 calculates the weight coefficient for the slice for Inplicit mode.

In step S253, the difference motion information buffer 251 obtains the difference motion information extracted from the bit stream by the lossless decoding unit 202. The motion information restructuring unit 252 obtains the difference motion information from the difference motion information buffer 251. In step S254, the motion information restructuring unit 252 obtains the surrounding motion information held by the motion information buffer 253.

In step S255, the motion information restructuring unit 252 restructures the motion information about the region using the difference motion information about the region obtained in step S253 and the surrounding motion information obtained in step S254. In step S256, the prediction mode information buffer 256 obtains the optimum mode information extracted from the bit stream by the lossless decoding unit 202. The control unit 258 obtains the optimum mode information from the prediction mode information buffer 256. In step S257, the control unit 258 uses the optimum mode information to determine the mode of the motion compensation.

In step S258, the weight mode information buffer 257 obtains the optimum mode information extracted from the bit stream by the lossless decoding unit 202. The control unit 258 obtains the optimum weight mode information from the weight mode information buffer 257. In step S259, the control unit 258 uses the optimum mode information to determine the weight mode of the motion compensation.

In step S260, the control unit 258 obtains information required for the motion compensation in the optimum prediction mode determined in step S257 and the weight mode determined in step S259. In step S261, the motion compensation unit 259 uses the information obtained in step S260 to perform the motion compensation in the optimum prediction mode determined in step S257 and the weight mode determined in step S259, and generates a prediction image.

In step S262, the motion compensation unit 259 provides the prediction image generated in step S261 to the calculation unit 205. In step S263, the motion information buffer 253 stores the motion information restructured in step S255.

When the processing in step S263 is finished, the motion information buffer 253 terminates the inter-motion prediction processing, and returns back to the processing in FIG. 16.

As described above, by performing each processing, the motion prediction/compensation unit 212 performs motion compensation in accordance with motion prediction/compensation processing performed by the image coding device 100 on the basis of the information transmitted from the image coding device 100, and generates a prediction image. More specifically, the motion prediction/compensation unit 212 performs motion compensation in accordance with motion prediction/compensation processing performed by the image coding device 100 while controlling weight prediction on the basis of the information transmitted from the image coding device 100, and generates a prediction image. Therefore, the image decoding device 200 can achieve suppression of reduction of the prediction precision of the weight prediction which occurs with the image coding device 100, and can achieve improvement of the coding efficiency.

### Other Examples

In the above explanation, the weight mode is controlled in each smaller region, but the control unit of the weight mode may be of any size as long as it is a region smaller than slice. For example, it may be LCU, CU, or PU, or may be a macro block or a sub-macro block.

In each of such regions, the weight mode may be controlled, and the value of the weight coefficient may also be controlled. In this case, however, it is necessary to transmit the weight coefficient, and the coding efficiency may be reduced due to this transmission. As described above, in the method for controlling the weight mode according to the weight mode information, the control processing of the weight prediction can be performed more easily.

In the above explanation, the ON/OFF state of the weight prediction has been explained as the control of the weight mode, but the embodiment is not limited thereto. For example, it may be possible to control whether the weight prediction is performed in Explicit mode in which the weight coefficient (W, D, and the like) is transmitted or the weight prediction is performed in Inplicit mode in which the weight coefficient (W, D, and the like) is not transmitted.

In the control of the weight mode, there may be three or more candidates of optimum weight modes. For example, three weight modes including a mode in which the weight prediction is not performed (OFF), a mode in which the weight prediction is performed in Explicit mode, and a mode in which the weight prediction is performed in Inplicit mode may be used as candidates of optimum weight modes.

In the control of the weight mode, the value of the weight coefficient may be selected. For example, the weight coefficient of each candidate of optimum weight mode may be different from each other, and the weight coefficient may be selected by selecting the optimum weight mode. For example, a weight mode having a weight coefficient w0, a weight mode having a weight coefficient w1, and a weight mode having a weight coefficient w2 may be used as candidates, and any one of them may be selected as the optimum weight mode.

The control of the weight mode explained above is effective for not only the image as shown in FIG. 9 but also an image in which brightness change is not uniform in the entire image. For example, even when the entire image is a natural image, brightness change may occur partially, or the degree of brightness change may be different in each portion. If the weight prediction is performed on such image with a weight coefficient which is uniform in the entire image, a weight coefficient which is not suitable for none of the portions may be generated, and if the weight prediction is performed with such weight coefficient, the prediction precision may be reduced, and the coding efficiency may be reduced.

Accordingly, for example, by controlling the weight mode as described above, the image coding device 100 can perform optimum weight prediction in each portion.

Further, the weight modes explained above may be combined as candidates, and weight modes other than those explained above may be used as candidate.

Still further, the candidate in the inter-prediction mode and the candidate in the weight mode may be merged as options. For example, a mode 0 may be a weight mode in inter-prediction mode having a region size of 16 by 16 and having a weight coefficient w0, a mode 1 may be a weight mode in inter-prediction mode having a region size of 16 by 16 and having a weight coefficient w1, a mode 2 may be a weight mode in inter-prediction mode having a region size of 16 by 16 and having a weight coefficient w2, and a mode 3 may be a weight mode in inter-prediction mode having a region size of 8 by 8 and having a weight coefficient w0. As described above, the inter-prediction mode and the weight mode are represented in a set of mode, whereby the coding efficiency can be improved.

As described above, the inter-prediction information including the optimum mode information and the optimum weight mode information is provided to the lossless coding unit 106, and is coded with CABAC, CAVLC, and the like, and is attached to the bit stream. By performing coding with CABAC, only points of variations are included in the bit stream. In an image in general, brightness change is less likely to be different in each small region. In the example of FIG. 9, the brightness change does not occur only in regions close to right and left ends of the image, and the brightness change in the central portion is uniform. Even if not uniform, the correlation of the brightness change is likely to increase as the distance becomes closer. Therefore, the change of the optimum weight mode within the picture is not much as compared with the number of regions of prediction processing units. Accordingly, by coding the optimum weight mode information according to an encoding method such as CABAC, the image coding device 100 can improve the coding efficiency.

It should be noted that the optimum weight mode information may be encoded only at a point of variation. More specifically, only when the optimum weight mode changes from a region inter-predicted previously, optimum weight mode information indicating the changed weight mode may be encoded, and transmitted to the decoding side. More specifically, in this case, when the weight mode information cannot be obtained in the region inter-predicted, the image decoding device 200 performs processing assuming that the weight mode of the region is the same as that of the region inter-predicted that is processed previously.

### 3. Third Embodiment

### Image Coding Device

When the region of prediction processing target is small, the entire image is hardly affected by some reduction of the prediction precision of any weight prediction. Therefore, in order to reduce the load of control processing of the weight mode, it may be possible to set a lower limit of the size of the region in which the weight mode is controlled.

For example, the optimum weight mode information may be transmitted for only Coding Unit of a certain size or more. In this case, information indicating the smallest size of Coding Unit for which the optimum weight mode information is transmitted may be transmitted in a picture parameter set and a slice header to the decoding side.

When a larger region is the lower limit of transmission of the optimum weight mode information, this can suppress overhead of increase of the amount of codes caused by the transmission of the optimum weight mode information. In contrast, when a smaller region is the lower limit of the transmission of the optimum weight mode information, the prediction efficiency can be further improved.

For a small region for which the optimum weight mode information is not transmitted, the motion prediction/compensation may be performed in weight ON mode, or the motion prediction/compensation may be performed in weight OFF mode.

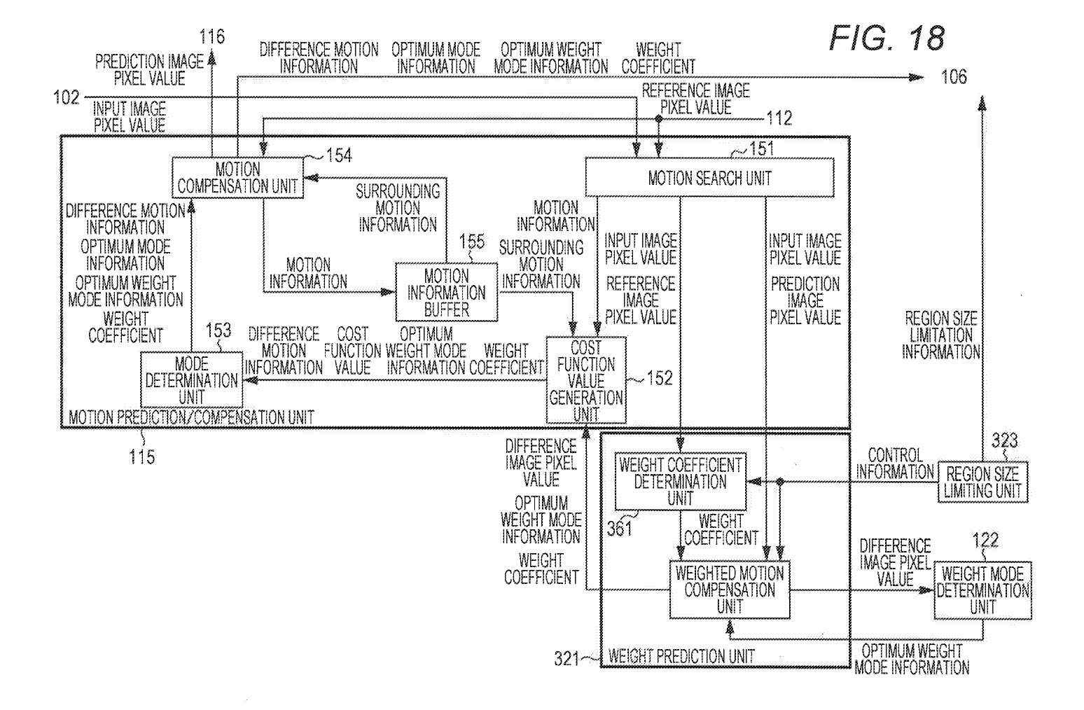

FIG. 18 is a block diagram illustrating an example of main configuration of a portion of the image coding device 100 in this case. As shown in FIG. 18, the image coding device 100 in this case includes a weight prediction unit 321 instead of the weight prediction unit 121 in the case of FIG. 1, and further includes a region size limiting unit 323.

The region size limiting unit 323 provides the weight coefficient determination unit 361 and the weighted motion compensation unit 362 of the weight prediction unit 321 with control information indicating the lower limit of the size of the region in which the weight prediction is controlled. The region size limiting unit 323 provides the region size limitation information indicating the region size to the lossless coding unit 106, and causes the lossless coding unit 106 to encode the information, and then the information is transmitted to the decoding side in such a manner that it is included in the bit stream.

The weight prediction unit 321 includes a weight coefficient determination unit 361 and a weighted motion compensation unit 362.

The weight coefficient determination unit 361 determines the weight coefficient for the slice, and the weight coefficient as well as the input image and the reference image are provided to the weighted motion compensation unit 362. Only for a region larger than the region size designated by the limitation information provided from the region size limiting unit 323, the weighted motion compensation unit 362 performs, e.g., the motion compensation in weight ON state, calculation of the difference image, and providing the optimum weight mode information to the cost function value generation unit 152, which are explained in the first embodiment.

When the motion prediction/compensation in weight OFF state is performed on the region of which size is equal to or less than the region size designated by the limitation information, the weighted motion compensation unit 362 provides the cost function value generation unit 152 with the difference image pixel values in weight OFF state for the region of which size is equal to or less than the region size.

When the motion prediction/compensation in weight ON state is performed on the region of which size is equal to or less than the region size designated by the limitation information, the weighted motion compensation unit 362 provides the cost function value generation unit 152 with the difference image pixel values in weight ON state and the weight coefficient for the region of which size is equal to or less than the region size.

By doing so, the image coding device 100 can reduce the load of the control processing of the weight prediction by any given degree.

### [Flow of Inter-Motion Prediction Processing]

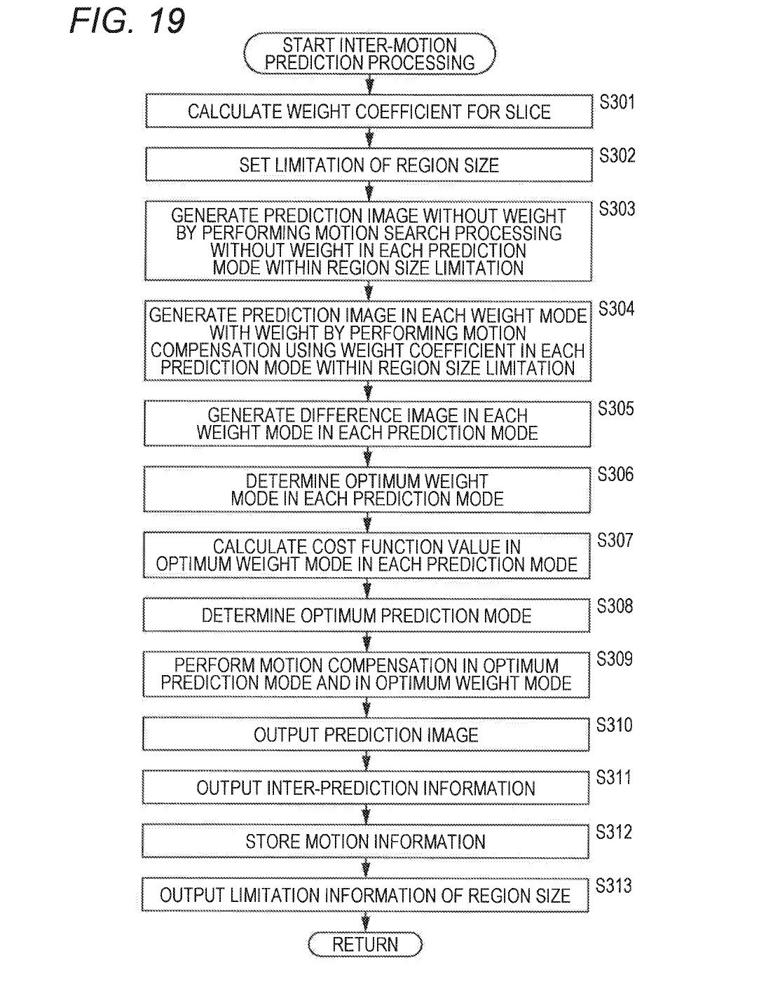

An example of flow of the inter-motion prediction processing in this case will be explained with reference to the flowchart of FIG. 19. In this case, each processing is performed in basically the same way as the case of the first embodiment explained with reference to FIG. 12.

However, in this case, in step S302, the region size limiting unit 323 sets the limitation of the region size. Each processing in step S304 to step S306 is performed in each inter-prediction mode within the region size limitation.

Then, in step S313, the region size limiting unit 323 provides the region size limitation information to the lossless coding unit 106, and causes the lossless coding unit 106 to encode the information, and then the information is transmitted to the decoding side in such a manner that it is included in the bit stream.

Step S301 is executed in the same manner as step S131. Step S303 is executed in the same manner as step S132. The processing in step S307 to step S312 is executed in the same manner as the processing in step S136 to step S141, respectively.

When the processing in step S313 is finished, the region size limiting unit 323 returns back to the processing in FIG. 11.

In the above explanation, the flow of processing has been explained in which the motion prediction/compensation in weight OFF mode is performed on a region of which size is equal to or less than the region size designated by the limitation information. When the motion prediction/compensation in weight ON mode is performed on a region of which size is equal to or less than the region size designated by the limitation information, the processing in step S303 may be performed in each inter-prediction mode within the region size limitation, and the processing in step S304 may be performed in all the inter-prediction modes.

By performing the above processing, the image coding device 100 can reduce the load of the control processing of the weight prediction by any given degree.

### 4. Fourth Embodiment

### Image Decoding Device

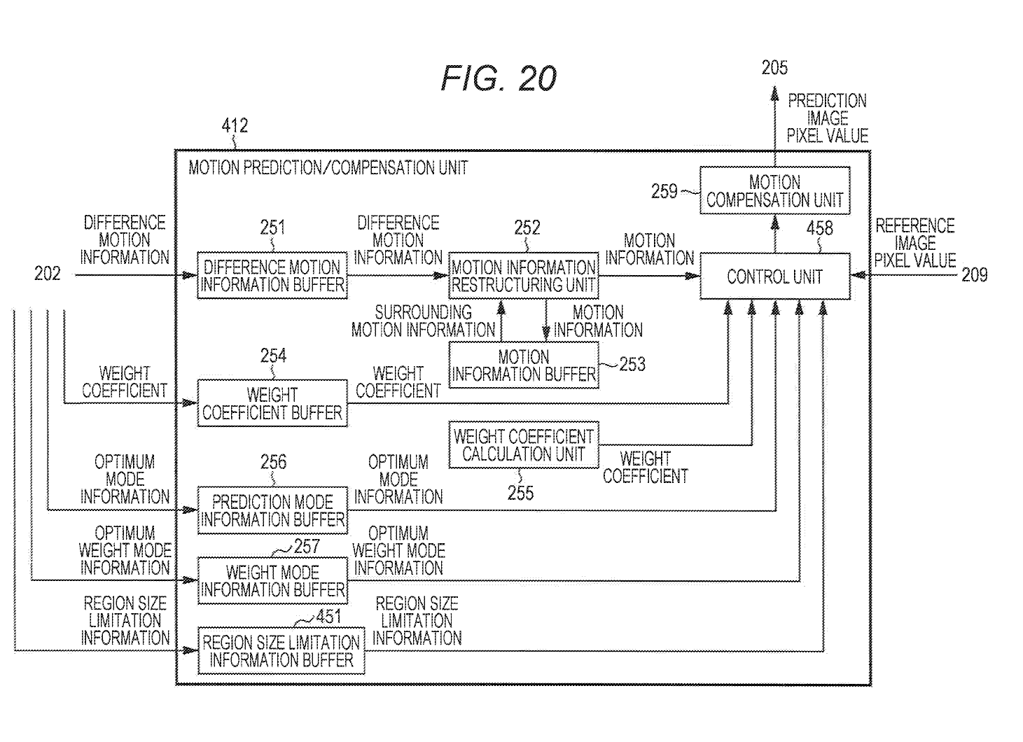

Subsequently, an image decoding device corresponding to the image coding device 100 of the third embodiment will be explained. FIG. 20 is a block diagram for explaining an example of main configuration of a motion prediction/compensation unit provided in the image decoding device 200 in this case.

As shown in FIG. 20, the image decoding device 200 in this case includes a motion prediction/compensation unit 412 instead of the motion prediction/compensation unit 212.

As shown in FIG. 20, the motion prediction/compensation unit 412 basically has the same configuration as the motion prediction/compensation unit 212, but further includes a region size limitation information buffer 451. The motion prediction/compensation unit 412 includes a control unit 458 instead of the control unit 258. The region size limitation information buffer 451 obtains and stores the region size limitation information extracted from the bit stream by the lossless decoding unit 202, i.e., the region size limitation information explained in the third embodiment transmitted from the image coding device 100. The region size limitation information buffer 451 provides the region size limitation information to the control unit 458 with predetermined timing or on the basis of external request.

The control unit 458 analyzes the optimum weight mode information in accordance with the region size limitation information, and determines the weight mode. More specifically, the control unit 458 looks up the optimum weight mode information to determine the weight mode only a region of which size is more than the region size designated by the region size limitation information. For a region of which size is equal to or less than the region size designated by the region size limitation information, the control unit 458 sets the predetermined weight mode without referring to the optimum weight mode information.

By doing so, the motion compensation unit 259 can perform the motion compensation in the same manner as the motion compensation unit 154. Accordingly, the image decoding device 200 can reduce the load of the control processing of the weight prediction.

### [Flow of Inter-Motion Prediction Processing]

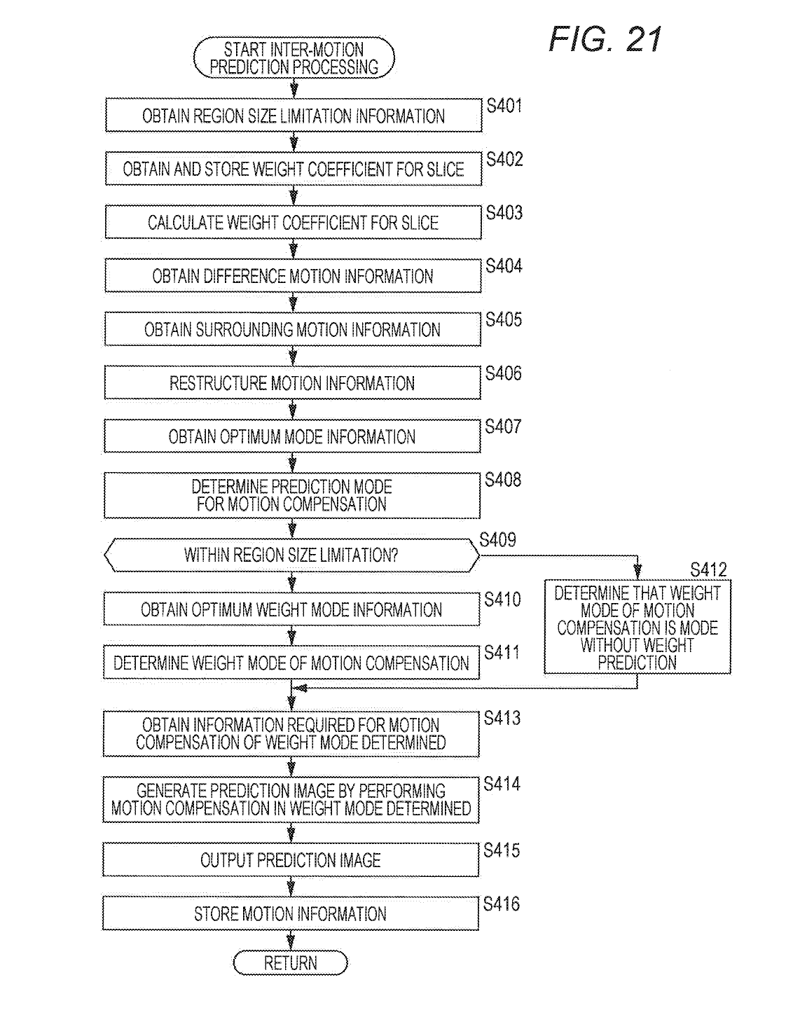

An example of flow of the inter-motion prediction processing in this case will be explained with reference to the flowchart of FIG. 21. In this case, each processing is performed in basically the same way as the case of the second embodiment explained with reference to FIG. 17.

However, in this case, in step S401, the region size limitation information buffer 451 obtains and stores the region size limitation information. The control unit 259 obtains the region size limitation information from the region size limitation information buffer 451.

The processing in step S402 to step S408 is executed in the same manner as the processing in step S251 to step S257, respectively.

In step S409, the control unit 458 determines whether the size of the region of the processing target is within the region size limitation or not, and when it is determined to be within the limitation, the processing in step S410 is subsequently performed. Each processing in step S410 and step S411 is performed in the same manner as step S258 and step S259. When the processing in step S411 is finished, the control unit 458 subsequently performs the processing in step S413.

In step S409, when the size of the region of the processing target is determined not to be within the region size limitation, the control unit 458 subsequently performs the processing in step S412, and determines that the weight mode of the motion compensation is the mode without the weight prediction. When the processing in step S412 is finished, the control unit 458 subsequently performs the processing in step S413.

The processing in step S413 to step S416 is executed in the same manner as the processing in step S260 to step S263, respectively.

When the processing in step S416 is finished, the motion information buffer 253 returns k to the processing in FIG. 16.

In the above explanation, the flow of processing has been explained in which the motion prediction/compensation in weight OFF mode is performed on a region of which size is equal to or less than the region size designated by the limitation information. When the motion prediction/compensation in weight ON mode is performed on a region of which size is equal to or less than the region size designated by the limitation information, the control unit 458 may determine that the weight mode of the motion compensation is the mode with the weight prediction in step S412.

By performing the above processing, the image decoding device 200 can reduce the load of the control processing of the weight prediction.

### 5. Fifth Embodiment

[Image coding device] In the above explanation, an example of procedure of motion prediction/compensation processing has been explained, but a procedure other than the above may be used.

For example, the cost function values are generated in all the weight modes in all the inter-prediction modes, and a combination of the optimum inter-prediction mode and the weight mode may be derived from among them.

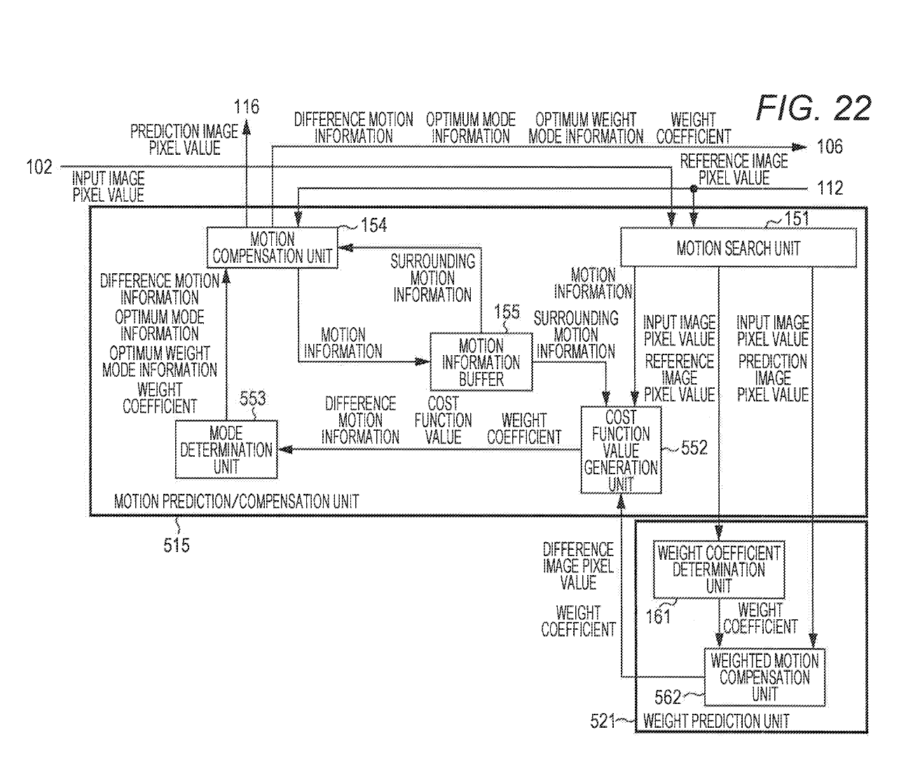

FIG. 22 is a block diagram illustrating an example of main configuration of a portion of the image coding device 100 in this case. As shown in FIG. 22, the image coding device 100 in this case includes a motion prediction/compensation unit 515 instead of the motion prediction/compensation unit 115. The image coding device 100 in this case includes a weight prediction unit 521 instead of the weight prediction unit 121. It should be noted that the weight mode determination unit 122 is omitted.

The motion prediction/compensation unit 515 basically has the same configuration as the motion prediction/compensation unit 115, but has a cost function value generation unit 552 instead of the cost function value generation unit 152, and has a mode determination unit 553 instead the mode determination unit 153.

The weight prediction unit 521 basically has the same configuration as the weight prediction unit 121, but has a weighted motion compensation unit 562 instead of the weighted motion compensation unit 162.

The weighted motion compensation unit 562 generates the difference image in all the weight modes in all the inter-prediction modes. The weighted motion compensation unit 562 provides the difference image pixel values and the weight coefficient in all the inter-prediction modes and in all the weight modes to the cost function value generation unit 552.

The cost function value generation unit 552 calculates the cost function values using difference image pixel values in all the inter-prediction modes and in all the weight modes. Like the case of the cost function value generation unit 152, the cost function value generation unit 552 generates the difference motion information between the surrounding motion information and the motion information about the region in all the inter-prediction modes and in all the weight modes.

The cost function value generation unit 552 provides the mode determination unit 553 with the difference motion information and the cost function values as well as the weight coefficients in all the inter-prediction modes and in all the weight modes.

The mode determination unit 553 determines the optimum inter-prediction mode and the optimum weight, mode using the cost function values in all the inter-prediction modes and all the weight modes provided.

The processing other than the above is the same as the case of the motion prediction/compensation unit 115.

By doing so, the image coding device 100 can accurately obtain the optimum inter-prediction mode and the optimum weight mode, and can further improve the coding efficiency.

### [Flow of Inter-Motion Prediction Processing]

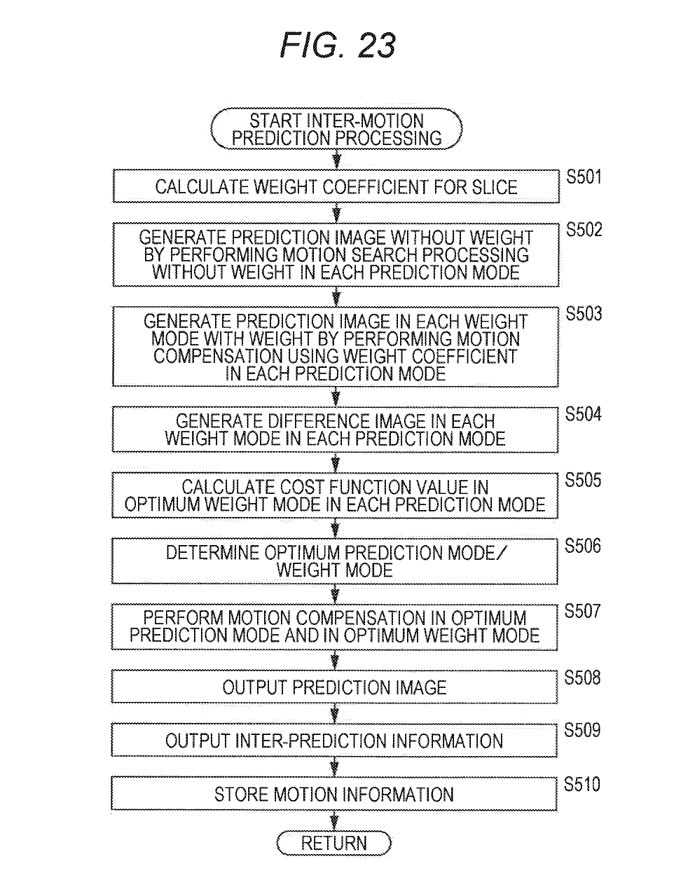

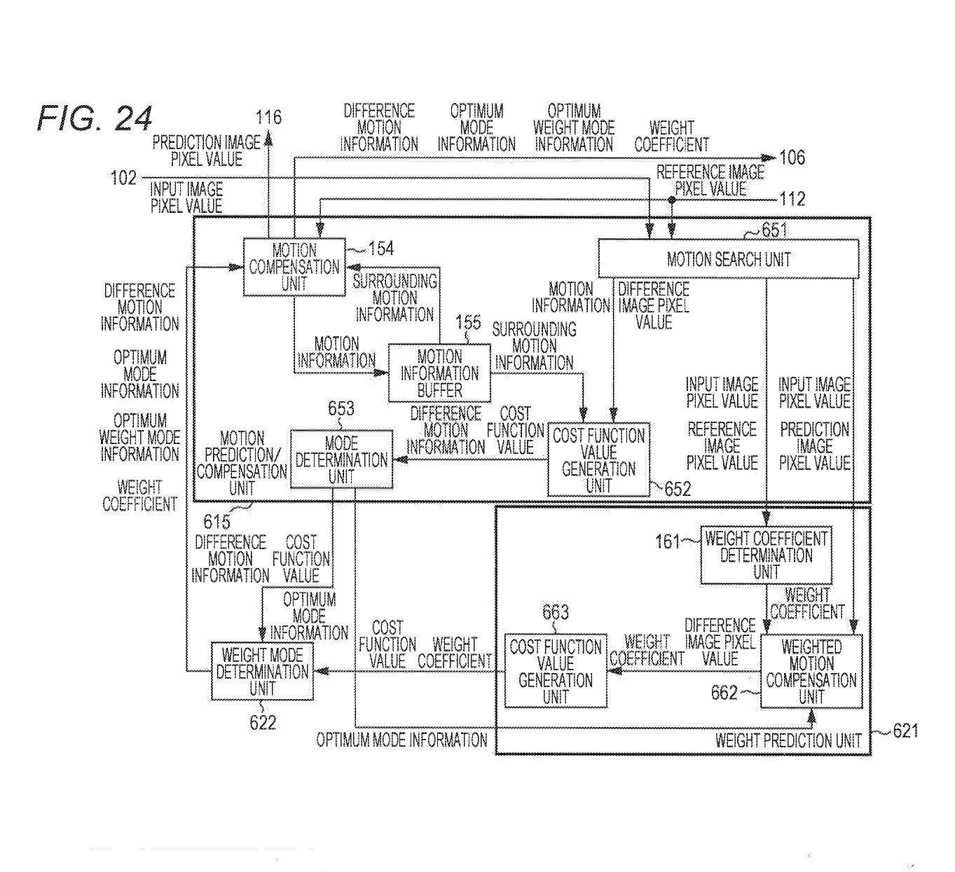

An example of flow of the inter-motion prediction processing in this case will be explained with reference to the flowchart of FIG. 23.

In this case, the inter-motion prediction processing is also executed basically in the same manner as the first embodiment explained with reference to the flowchart of FIG. 12.

More specifically, the processing in step S501 to step S504 is executed in the same manner as the processing in step S131 to step S134, respectively. However, the processing in step S135 is omitted.

In step S505, the cost function generation unit 552 calculates the cost function value in each weight mode and each inter-prediction mode. In step S506, the mode determination unit 503 determines the optimum weight mode and the optimum inter-prediction mode.

The processing in step S507 to step S510 is executed in the same manner as the processing in step S138 to step S141 in FIG. 12, respectively.

By performing the above processing, the image coding device 100 can accurately obtain the optimum inter-prediction mode and the optimum weight mode, and can further improve the coding efficiency.

### 6. Sixth Embodiment

### Image Coding Device

For example, after the optimum inter-prediction mode is determined in the predetermined weight mode, the optimum weight mode for the inter-prediction mode may be determined.

FIG. 24 is a block diagram illustrating an example of configuration of a portion of the image coding device 100 in this case. As shown in FIG. 24, the image coding device 100 in this case includes a motion prediction/compensation unit 615 instead of the motion prediction/compensation unit 115. The image coding device 100 in this case includes a weight prediction unit 621 instead of the weight prediction unit 121. Further, the image coding device 100 in this case has a weight mode determination unit 622 instead of the weight mode determination unit 122.

The motion prediction/compensation unit 615 basically has the same configuration as the motion prediction/compensation unit 115, but has a motion search unit 651 instead of the motion search unit 151, and has a cost function value generation unit 652 instead of the cost function value generation unit 152, and has a mode determination unit 653 instead the mode determination unit 153.

The weight prediction unit 621 basically has the same configuration as the weight prediction unit 121, but has a weighted motion compensation unit 662 instead of the weighted motion compensation unit 162, and further includes a cost function value generation unit 663.

The motion search unit 651 performs motion search in weight OFF state in all the inter-prediction modes, and provides the cost function value 652 with the difference image pixel values in weight OFF state and the motion information.

The cost function value generation unit 652 calculates the cost function value of the weight mode in weight OFF state in all the inter-prediction modes, and generates difference motion information between the surrounding motion information and the motion information about the region, and the difference motion information as well as the difference motion information are provided to the mode determination unit 653.

The mode determination unit 653 determines the optimum inter-prediction mode on the basis of the cost function value, and provides the optimum mode information to the weighted motion compensation unit 662 of the weight prediction unit 621. The mode determination unit 653 provides the optimum mode information to the weight mode determination unit 622. With regard to the optimum inter-prediction mode, the mode determination unit 653 provides the weight mode determination unit 622 with the difference motion information and the cost function value of the weight mode in weight OFF state.

With regard to the optimum inter-prediction mode, the weighted motion compensation unit 662 of the weight prediction unit 621 performs the motion compensation in weight ON mode, and generates difference image between the prediction image and the input image. The weighted motion compensation unit 662 provides the cost function value generation unit 663 with the difference image pixel values and the weight coefficient in weight ON mode of the optimum inter-prediction mode.

The cost function value generation unit 663 generates the cost function value of the difference image pixel value, and provides the value as well as the weight coefficient to the weight mode determination unit 622.

The weight mode determination unit 622 determines the optimum weight mode by comparing the cost function values provided from the mode determination unit 653 and the cost function value generation unit 663.

The weight mode determination unit 663 provides the difference motion information, the optimum mode information, the optimum weight mode information, and the weight coefficient to the motion compensation unit 154.

The processing other than the above is the same as the case of the motion prediction/compensation unit 115.

By doing so, the image coding device 100 can more easily perform the processing for selecting the optimum mode, and can reduce the load.

### [Flow of Inter-Motion Prediction Processing]

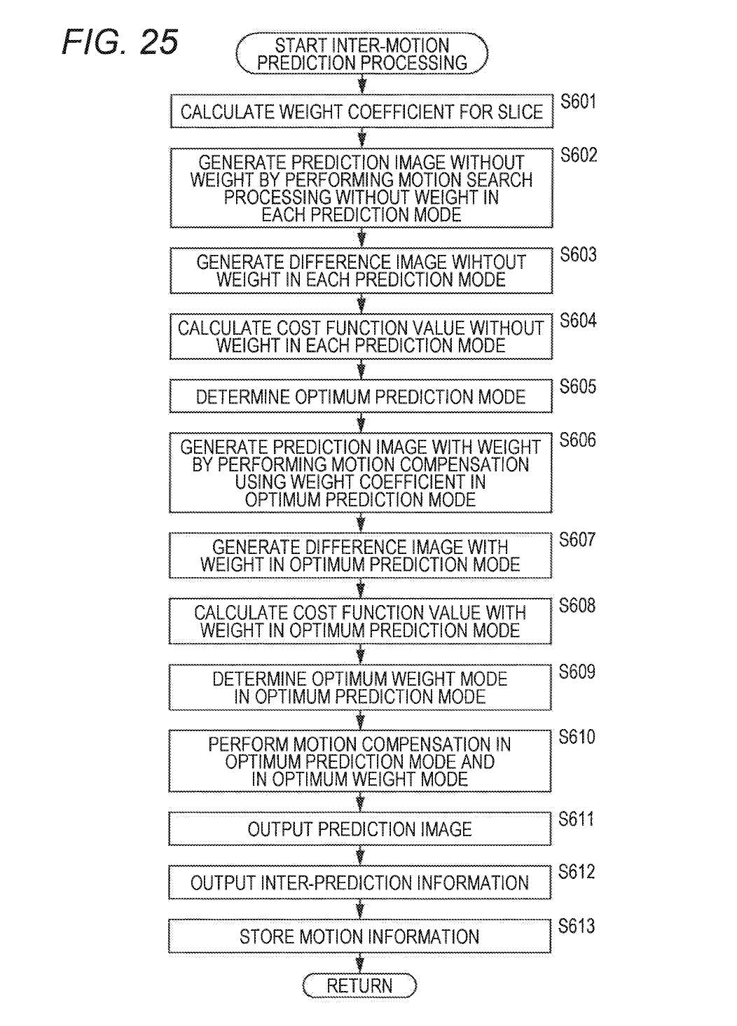

An example of flow of the inter-motion prediction processing in this case will be explained with reference to the flowchart of FIG. 25.

In this case, the inter-motion prediction processing is also executed basically in the same manner as the first embodiment explained with reference to the flowchart of FIG. 12.

More specifically, the processing in step S601 and step S602 is executed in the same manner as the processing in step S131 and step S132, respectively.

In step S603, the motion search unit 651 generates the difference image in weight OFF mode in all inter-prediction modes. In step S604, the cost function value generation unit 652 calculates the cost function value in the weight OFF mode in all inter-prediction modes.

In step S605, the mode determination unit 653 determines the optimum weight mode in the weight OFF mode.

In step S606, the weighted motion compensation unit 662 performs the motion compensation using the weight coefficient in the optimum inter-prediction mode, and generates a prediction image in weight ON mode. In step S607, the weighted motion compensation unit 662 generates a difference image in weight ON state in the optimum inter-prediction mode. In step S608, the cost function value generation unit 663 calculates the cost function value in the optimum inter-prediction mode. In step S609, the weight mode determination unit 622 determines the optimum weight mode in the optimum inter-prediction mode.

The processing in step S610 to step S613 is executed in the same manner as the processing in step S138 to step S141, respectively.

By performing the above processing, the coding device 100 can easily perform the processing of selecting the optimum mode, and can reduce the load.

For example, the present technique can be applied to an image coding device and an image decoding device which are used when receiving image information (bit stream) compressed by orthogonal transformation such as discrete cosine transform and motion compensation such as MPEG, H.26x, via network medium such as satellite broadcast, cable television, the Internet, or cellular phone. The present technique can be applied to an image coding device and an image decoding device used for processing on recording media such as optical, magnetic disks, and flash memories. Further, this technique can also be applied to an intra-prediction device included in the image coding device, the image decoding device, and the like.

### 7. Seventh Embodiment

### Personal Computer

The above series of processing may be executed by hardware, or may be executed by software. When the series of processing is executed by software, programs constituting the software are installed to the computer. In this case, the computer includes a personal computer embedded into dedicated hardware and a general-purpose computer capable of executing various kinds of functions by installing various kinds of programs.

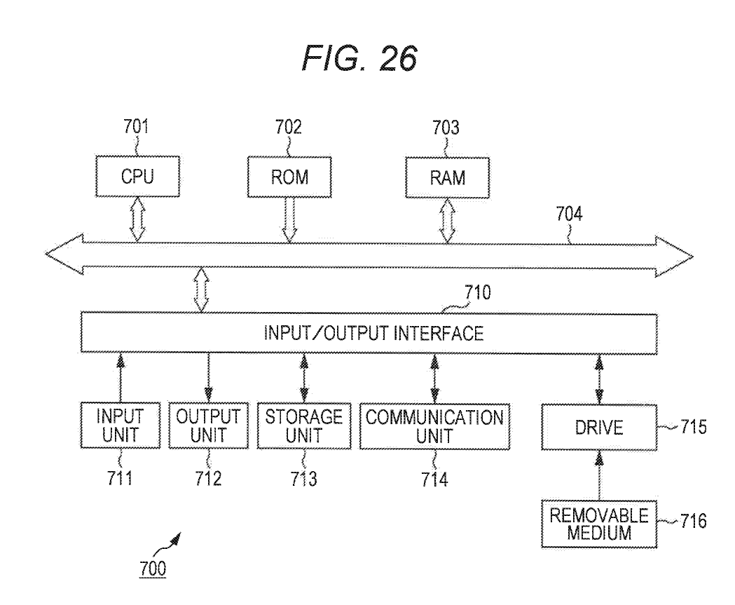

In FIG. 26, a CPU (Central processing Unit) 701 of a personal computer 700 executes various kinds of processing in accordance with a program stored in a ROM (Read Only Memory) 702 or program loaded from a storage unit 713 to a RAM (Random Access Memory) 703. As necessary, the RAM 703 also stores, e.g., data required for allowing the CPU 701 to execute various kinds of processing.

The CPU 701, the ROM 702, and the RAM 703 are connected to each other via a bus 704. This bus 704 is also connected to an input/output interface 710.

The input/output interface 710 is connected to an input unit 711 made of a keyboard, a mouse, and the like, a display made of a CRT (Cathode Ray Tube), an LCD (Liquid Crystal Display), and the like, an output unit 712 made of a speaker and the like, a storage unit 713 constituted by a hard disk and the like, and a communication unit 714 constituted by a modem and the like. The communication unit 714 performs communication processing via a network including the Internet.

The input/output interface 710 is also connected to a drive 715 as necessary, and removable medium 721 such as a magnetic disk, an optical disk, a magneto-optical disk, or a semiconductor memory is loaded as necessary, and a computer program read therefrom is installed to a storage unit 713 as necessary.

When the above series of processing is executed by software, programs constituting the software are installed from a network or a recording medium.

For example, as illustrated in FIG. 26, this recording medium is constituted by not only a removable medium 721 made of, e.g., a magnetic disk (including a flexible disk) recorded with a program, an optical disk (including CD-ROM (Compact Disc-Read Only Memory), a DVD (Digital Versatile Disc)), a magneto optical disk (including MD (Mini Disc)), or a semiconductor memory, which are distributed to distribute programs to users separately from the device main body but also a ROM 702 recorded with a program and a hard disk included in the storage unit 713 which are distributed to users while they are incorporated into the device main body in advance.

The program executed by the computer may be a program with which processing in performed in time sequence according to the order explained in this specification, or may be a program with which processing is performed in parallel or with necessary timing, e.g., upon call.

In this specification, steps describing the program recorded in the recording medium include processing performed in time sequence according to the described order. The steps may not be necessarily performed in time sequence, and the steps include processing executed in parallel or individually.

In this specification, the system includes the entire apparatus constituted by a plurality of devices.

A configuration explained as a device (or a processing unit) in the above explanation may be divided, and structured as multiple devices (or processing units). A configuration explained as multiple devices (or processing units) in the above explanation may be combined, and structured as a device (or a processing unit). Alternatively, it is to be understood that the configuration of each device (or each processing unit) may be added with any configuration other than the above. Further, when the configuration and operation of the entire system are substantially the same, a part of configuration of a certain device (or processing unit) may be included in the configuration of another device (or another processing unit). More specifically, this technique is not limited to the above embodiment, and may be changed in various manners as long as it is within the gist of this technique.

The image coding device and image decoding device according to the embodiments explained above can be applied to various kinds of electronic devices such as a transmitter or a receiver for distribution to terminals by satellite broadcasting, cable broadcasting such as cable television, distribution on the Internet, cellular communication, recording devices for recording images to a medium such as an optical disk, magnetic disk, and flash memory, or a reproduction device for reproducing images from these recording media. Hereinafter, four examples of applications will be explained.

### 8. Eighth Embodiment

### First Example of Application

### Television Receiver

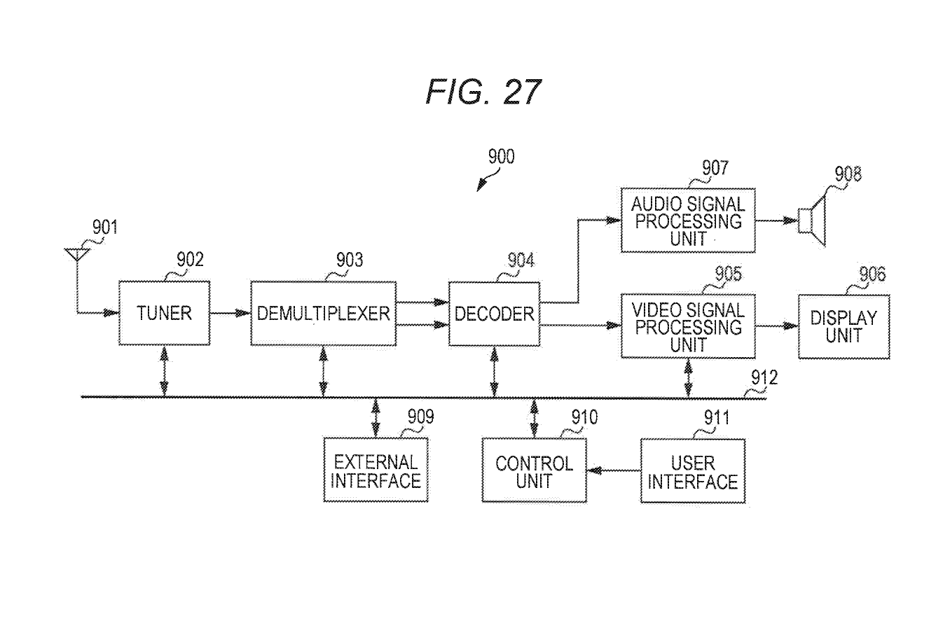

FIG. 27 illustrates an example of schematic configuration illustrating a television device to which the above embodiments are applied. The television device 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from a broadcasting signal received via the antenna 901, and demodulates the extracted signal. Then, the tuner 902 outputs the encoded bit stream obtained from demodulation to the demultiplexer 903. More specifically, the tuner 902 plays a role of transmission means of the television device 900 for receiving the encoded bit stream in which images are encoded.

The demultiplexer 903 separates the video stream and the audio stream of a viewing target program from the encoded bit stream, and outputs each separated stream to the decoder 904. The demultiplexer 903 extracts auxiliary data such as EPG (Electronic Program Guide) from the encoded hit stream, and provides the extracted data to the control unit 910. When the encoded bit stream is scrambled, the demultiplexer 903 may perform descrambling.

The decoder 904 decodes the video stream and the audio stream received from the demultiplexer 903. Then, decoder 904 outputs the video data generated from the decoding processing to the video signal processing unit 905. The decoder 904 outputs the audio data generated from the decoding processing to the audio signal processing unit 907.

The video signal processing unit 905 plays the video data received from the decoder 904, and causes the display unit 906 to display the video. The video signal processing unit 905 may display, on the display unit 906, an application screen provided via the network. The video signal processing unit 905 may perform additional processing such as noise reduction on the video data in accordance with setting. Further, the video signal processing unit 905 generates an image of GUI (Graphical User Interface) such as menu, buttons, or cursor, and overlays the generated image on the output image.

The display unit 906 is driven by a driving signal provided from the video signal processing unit 905, and displays video or image on a video screen of a display device (such as liquid crystal display, plasma display or OELD (Organic ElectroLuminescence Display) (organic EL display) and the like).

The audio signal processing unit 907 performs reproduction processing such as D/A conversion and amplification of audio data received from the decoder 904, and causes the speaker 908 to output audio. The audio signal processing unit 907 may perform additional processing such as noise reduction on the audio data.

The external interface 909 is an interface for connection between the television device 900 and external device or network. For example, a video stream or an audio stream received via the external interface 909 may be decoded by the decoder 904. More specifically, the external interface 909 also has a role of receiving the encoded bit stream in which images are encoded and as transmission means of the television device 900.

The control unit 910 has a memory such as a processor for a CPU and the like, and a RAN and a ROM. The memory stores, e.g., programs executed by the CPU, program data, EPG data, and data obtained via the network. The program stored in the memory may be, for example, read and executed by the CPU when the television device 900 is activated. The CPU executes the program to control operation of the television device 900 in accordance with operation signal received from the user interface 911, for example.

The user interface 911 is connected to the control unit 910. The user interface 911 includes, e.g., buttons and switches with which the user operates the television device 900, and a reception unit for receiving a remote control signal. The user interface 911 generates an operation signal by detecting user's operation via these constituent elements, and outputs the generated operation signal to the control unit 910.

The bus 912 connects the tuner 902, the demultiplexer 903, the decoder 904, the video signal processing unit 905, the audio signal processing unit 907, the external interface 909, and the control unit 910 with each other.

In the television device 900 configured as described above, the decoder 904 has a function of an image decoding device according to the embodiments explained above. Therefore, when the television device 900 decodes the image, the television device 900 improves the prediction precision by performing the control of the weight prediction in a smaller unit, thus achieving the improvement of the coding efficiency.

### 9. Ninth Embodiment

### Second Example of Application

### Cellular Phone

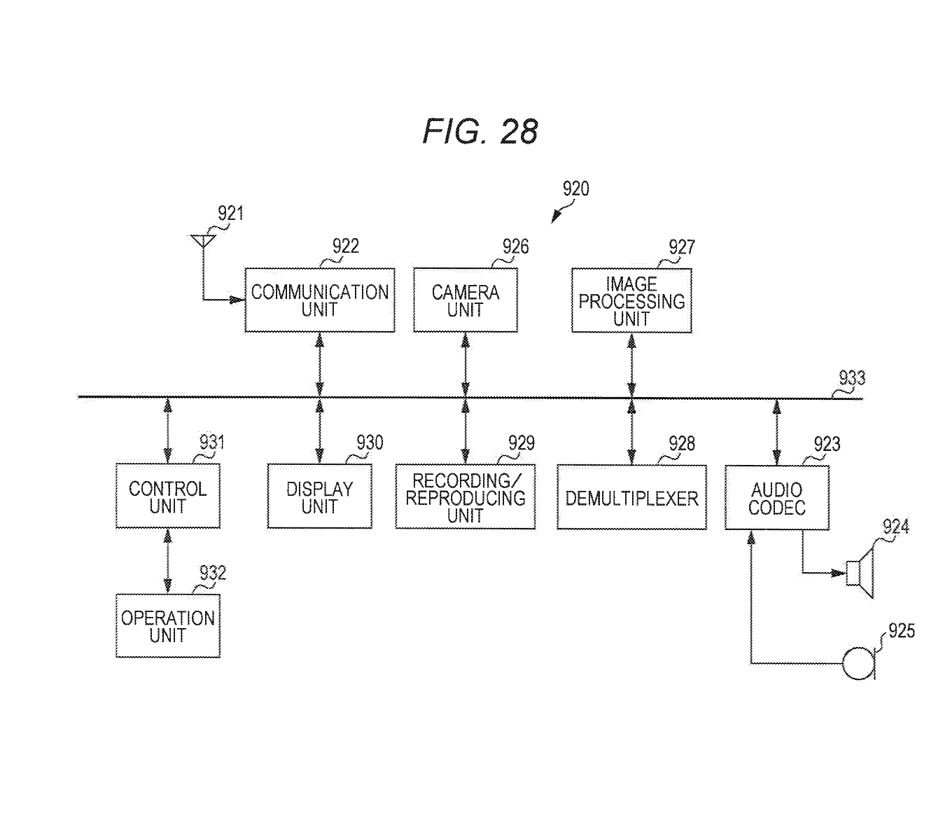

FIG. 28 illustrates an example of schematic configuration illustrating a cellular phone to which the above embodiments are applied. The cellular phone 920 includes an antenna 921, a communication unit 922, an audio codec 923, a speaker 924, a microphone 925, a camera unit 926, an image processing unit 927, a demultiplexer 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the demultiplexer 928, the recording/reproducing unit 929, the display unit 930, and the control unit 931 with each other.

The cellular phone 920 performs operation such as transmission/reception of audio signals, transmission/reception of e-mails or image data, capturing images, and recording data in various kinds of modes including audio phone call mode, data communication mode, shooting mode, and video call mode.

In the audio phone call mode, an analog audio signal generated by the microphone 925 is provided to the audio codec 923. The audio codec 923 converts an analog audio signal into audio data, performs A/D conversion on the converted audio data, and compresses the audio data. Then, the audio codec 923 outputs the compressed audio data to the communication unit 922. The communication unit 922 encodes and modulates the audio data, and generates a transmission signal. Then, the communication unit 922 transmits the generated transmission signal via the antenna 921 to the base station (not shown). The communication unit 922 amplifies a radio signal received via the antenna 921, and converts the frequency, and obtains a reception signal. Then, the communication unit 922 generates audio data by demodulating and decoding a reception signal, and outputs the generated audio data to the audio codec 923. The audio codec 923 decompresses the audio data, performs D/A conversion, and generates an analog audio signal. Then, the audio codec 923 provides the generated audio signal to the speaker 924, and outputs audio.

In the data communication mode, for example, the control unit 931 generates text data constituting an e-mail in accordance given with user's operation with operation unit 932. The control unit 931 displays characters on the display unit 930. The control unit 931 generates e-mail data in accordance with user's transmission instruction given with the operation unit 932, and outputs the generated e-mail data to the communication unit 922. The communication unit 922 encodes and modulates e-mail data, and generates a transmission signal. Then, the communication unit 922 transmits the generated transmission signal via the antenna 921 to the base station (not shown). The communication unit 922 amplifies a radio signal received via the antenna 921, and converts the frequency, and obtains a reception signal. Then, the communication unit 922 restores e-mail data by demodulating and decoding the reception signal, and outputs the restored e-mail data to the control unit 931. The control unit 931 displays the contents of the e-mail on the display unit 930, and stores the e-mail data to the recording medium of the recording/reproducing unit 929.

The recording/reproducing unit 929 has any given recording medium that can be read and written. For example, the recording medium may be an internal recording medium such as a RAM or a flash memory, and may be an externally-attached recording medium such as a hard disk, a magnetic disk, a magneto-optical disk, an optical disk, a USB (Unallocated Space Bitmap) memory, or a memory card.

In the shooting mode, for example, the camera unit 926 captures an image of a subject, generates image data, and outputs the generated image data to the image processing unit 927. The image processing unit 927 encodes the image data received from the camera unit 926, and records the encoded bit stream to the recording medium of the recording/reproducing unit 929.

In the video call mode, for example, the demultiplexer 928 multiplexes the video stream encoded by the image processing unit 927 and the audio stream received from the audio codec 923, and outputs the multiplexed stream to the communication unit 922. The communication unit 922 encodes and modulates the stream, and generates a transmission signal. Then, the communication unit 922 transmits the generated transmission signal via the antenna 921 to the base station (not shown). The communication unit 922 amplifies a radio signal received via the antenna 921, and converts the frequency, and obtains a reception signal. The transmission signal and the reception signal may include an encoded bit stream. Then, the communication unit 922 restores the stream by demodulating and decoding the reception signal, and outputs the restored stream to the demultiplexer 928. The demultiplexer 928 separates the video stream and the audio stream from the received stream, and outputs the video stream to the image processing unit 927 and the audio stream to the audio codec 923. The image processing unit 927 decodes the video stream, and generates video data. The video data are provided to the display unit 930, and the display unit 930 displays series of images. The audio codec 923 decompresses the audio stream, performs D/A conversion, and generates an analog audio signal. Then, the audio codec 923 provides the generated audio signal to the speaker 924, and outputs audio.

In the cellular phone 920 configured as described above, the image processing unit 927 has a function of the image coding device and the image decoding device according to the embodiments explained above. Therefore, when the cellular phone 920 encodes and decodes the image, the cellular phone 920 improves the prediction precision by performing the control of the weight prediction in a smaller unit, thus improving the coding efficiency.

### 10. Tenth Embodiment

### Third Example of Application

### Recording/Reproducing Device

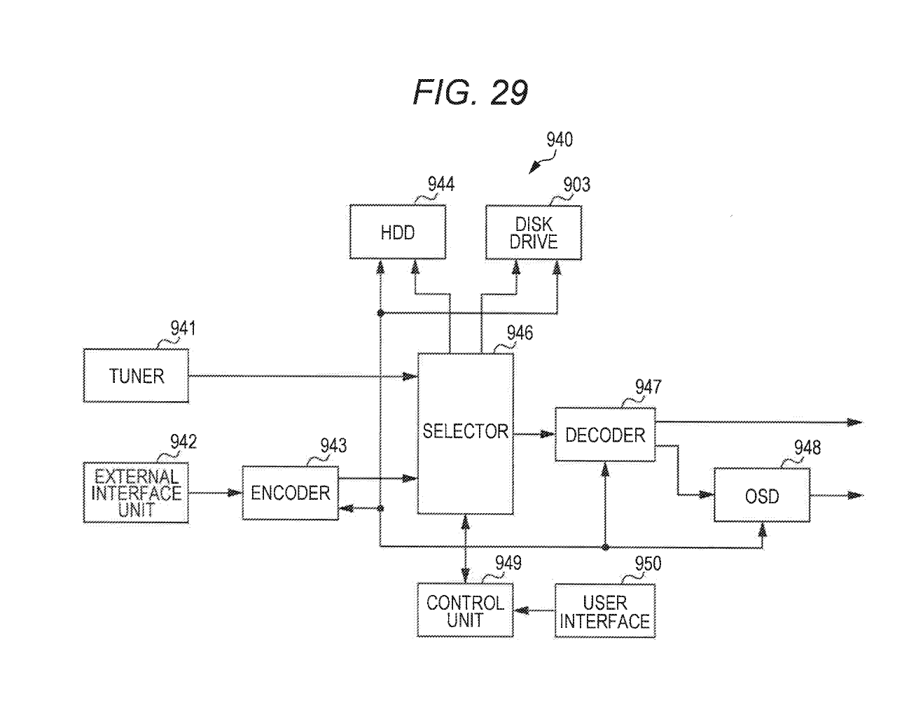

FIG. 29 illustrates an example of schematic configuration illustrating a recording/reproducing device to which the above embodiments are applied. For example, the recording/reproducing device 940 encodes the audio data and the video data of received broadcasting program, and records them to the recording medium. For example, the recording/reproducing device 940 may encode the audio data and the video data of obtained from another device, and may record them to the recording medium. For example, the recording/reproducing device 940 reproduces the data recorded on the recording medium using the monitor and the speaker in accordance with user's instruction. At this occasion, the recording/reproducing device 940 decodes the audio data and the video data.

The recording/reproducing device 940 includes a tuner 941, an external interface 942, an encoder 943, an HOD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcasting signal received via an antenna (not shown), and demodulates the extracted signal. Then, the tuner 941 outputs the encoded bit stream obtained from demodulation to the selector 946. More specifically, the tuner 941 plays the role of transmission means of the recording/reproducing device 940.

The external interface 942 is an interface for connection between the recording/reproducing device 940 and external device or network. The external interface 942 may be, for example, an IEEE1394 interface, a network interface, a USB interface, a flash memory interface, or the like. For example, the video data and audio data received via the external interface 942 are input into the encoder 943. More specifically, the external interface 942 plays the role of transmission means of the recording/reproducing device 940.

When the video data and the audio data received from the external interface 942 are not encoded, the encoder 943 encodes the video data and the audio data. Then, the encoder 943 outputs the encoded bit stream to the selector 946.

The HDD 944 records, within the internal hard disk, the encoded bit stream obtained by compressing the content data such as video and audio and, various kinds of programs, and other data When the video and audio are reproduced, the HDD 944 reads the data from the hard disk.

The disk drive 945 records and reads data to/from the recording medium loaded. The recording medium loaded to the disk drive 945 may be, for example, a DVD disk (DVD-Video, DVD-RAM, DVD-R, DVD-RW, DVD+R, DVD+RW, and the like) or Blu-ray (registered trademark) disk.

When the video and audio are recorded, the selector 946 selects the encoded bit stream received from the tuner 941 or the encoder 943, and outputs the selected encoded bit stream to the HDD 944 or the disk drive 945. When the video and audio are reproduced, the selector 946 outputs the encoded bit stream received from the HDD 944 or the disk drive 945 to the decoder 947.

The decoder 947 decodes the encoded bit stream, and generates video data and audio data Then, the decoder 947 outputs the generated video data to an OSD 948. The decoder 904 outputs the generated audio data to an external speaker.

The OSD 948 reproduces the video data received from the decoder 947, and displays video. The OSD 948 may overlays images of GUI such as menu, buttons, or cursor, on the displayed video.

The control unit 949 has a memory such as a processor for a CPU and the like, and a RAM and a ROM. The memory records programs executed by the CPU, program data, and the like. The program stored in the memory may be, for example, read and executed by the CPU when the recording/reproducing device 940 is activated. The CPU executes the program to control operation of the recording/reproducing device 940 in accordance with operation signal received from the user interface 950, for example.

The user interface 950 is connected to the control unit 949. The user interface 950 includes, e.g., buttons and switches with which the user operates the recording/reproducing device 940, and a reception unit for receiving a remote control signal. The user interface 950 generates an operation signal by detecting user's operation via these constituent elements, and outputs the generated operation signal to the control unit 949.

In the recording/reproducing device 940 configured as described above, the encoder 943 has a function of the image coding device according to the above embodiment. The decoder 947 has a function of an image decoding device according to the embodiments explained above. Therefore, when the recording/reproducing device 940 encodes and decodes the image, the recording/reproducing device 940 improves the prediction precision by performing the control of the weight prediction in a smaller unit, thus improving the coding efficiency.

### 11. Eleventh Embodiment

### Fourth Example of Application

### Image-Capturing Device

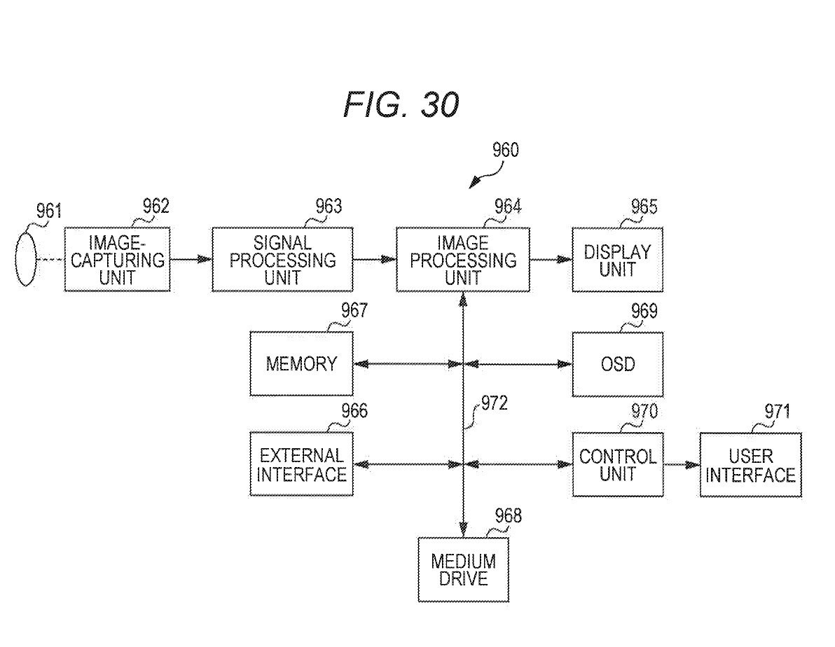

FIG. 30 illustrates an example of schematic configuration illustrating an image-capturing device to which the above embodiments are applied. An image-capturing device 960 captures an image of a subject, generates image data, and records the image data to a recording medium.

The image-capturing device 960 includes an optical block 961, an image-capturing unit 962, a signal processing unit 963, an image processing unit 964, a display unit 965, an external interface 966, a memory 967, a medium drive 968, an OSD 969, a control unit 970, a user interface 971, and a bus 972.

The optical block 961 is connected the image-capturing unit 962. The image-capturing unit 962 is connected to the signal processing unit 963. The display unit 965 is connected to the image processing unit 964. The user interface 971 is connected to the control unit 970. The bus 972 connects the image processing unit 964, the external interface 966, the memory 967, the medium drive 966, the OSD 969, and the control unit 970 with each other.

The optical block 961 includes a focus lens and a diaphragm mechanism. The optical block 961 causes an optical image of a subject to be formed on an image-capturing surface of the image-capturing unit 962. The image-capturing unit 962 includes an image sensor such as a CCD (Charge Coupled Device) or a CMOS (Complementary Metal Oxide Semiconductor), and converts the optical image formed on the image-capturing surface into an image signal which is an electric signal by photoelectric conversion. Then, the image-capturing unit 962 outputs the image signal to the signal processing unit 963.

The signal processing unit 963 performs various kinds of camera signal processing such as knee correction, gamma correction, and color correction on an image signal received from the image-capturing unit 962. The signal processing unit 963 outputs the image data which have been subjected to the camera signal processing to the image processing unit 964.

The image processing unit 964 encodes the image data received from the signal processing unit 963, and generates coded data. Then, the image processing unit 964 outputs the generated coded data to the external interface 966 or the medium drive 968. The image processing unit 964 decodes the coded data received from the external interface 966 or the medium drive 968, and generates image data. Then, the image processing unit 964 outputs the generated image data to the display unit 965. The image processing unit 964 may output the image data received from the signal processing unit 963 to the display unit 965, and may display the image thereon. The image processing unit 964 may also overlay display data obtained from the OSD 969 on the image which is to be output to the display unit 965.

For example, the OSD 969 may generate images of GUI such as menu, buttons, or cursor, and output the generated image to the image processing unit 964.

The external interface 966 is configured as, for example, a USB input/output terminal. The external interface 966 connects the image-capturing device 960 and a printer during printing of an image, for example. The external interface 966 is connected to a drive, as necessary. In the drive, for example, a removable medium such as a magnetic disk or an optical disk may be loaded. A program which is read from the removable medium may be installed to the image-capturing device 960. Further, the external interface 966 may be configured as a network interface connected to a network such as a LAN or the Internet. More specifically, the external interface 966 plays the role of transmission means of the image-capturing device 960.

The recording medium loaded to the medium drive 968 may be any given removable medium which can be read and written, such as a magnetic disk, an optical magnetic disk, an optical disk, or a semiconductor memory. The recording medium loaded to the medium drive 968 in a fixed manner, and, for example, a non-removable storage unit such as an internal hard disk drive or SSD (Solid State Drive) may be configured.

The control unit 970 has a memory such as a processor for a CPU and the like, and a RAM and a ROM. The memory records programs executed by the CPU, program data, and the like. The program stored in the memory may be, for example, read and executed by the CPU when the image-capturing device 960 is activated. The CPU executes the program to control operation of the image-capturing device 960 in accordance with operation signal received from the user interface 971, for example.

The user interface 971 is connected to the control unit 970. The user interface 971 includes, e.g., buttons and switches with which the user operates the image-capturing device 960. The user interface 971 generates an operation signal by detecting user's operation via these constituent elements, and outputs the generated operation signal to the control unit 970.

In the image-capturing device 960 configured as described above, the image processing unit 964 has a function of the image coding device and the image decoding device according to the embodiments explained above. Therefore, when the image-capturing device 960 encodes and decodes the image, the image-capturing device 960 improves the prediction precision by performing the control of the weight prediction in a smaller unit, thus improving the coding efficiency.

In the explanation of this specification, various kinds of information such as the difference motion information and the weight coefficient are multiplexed into the header of the bit stream, and transmitted from the coding side to the decoding side, for example. However, the method for transmitting information is not limited to such example. For example, such information may not be multiplexed into the hit stream, and may be transmitted or recorded as separate data associated with the bit stream. In this case, the term “associated” means that the image included in the bit stream (which may be a part of image such as slice or block) and information corresponding to the image is linked during decoding. More specifically, the information may be transmitted through a transmission path which is separate from the image (or bit stream). The information may be recorded to another recording medium which is different from the image (or bit stream) (or another recording area of the same recording medium). Further, the information and the image (or bit stream) may be associated with each other in any given unit such as multiple frames, a frame, or a portion of a frame.

The preferred embodiments of the present disclosure have been hereinabove described in detail with reference to attached drawings, but the present invention is not limited to such example. It is evident that a person who has ordinary knowledge in the technical field to which the present disclosure belongs would conceive of various kinds of examples of changes or modifications within the scope of the technical concept described in the claims, and it is to be understood that these are also included in the technical scope of the present disclosure.

It should be noted that this technique can also be configured as follows.

(1) An image processing device comprising: a weight mode determination unit, configured to determine, for each predetermined region, a weight mode which is a mode of weight prediction in which inter-motion prediction compensation processing for coding an image is performed while giving weight with a weight coefficient;

a weight mode information generation unit configured to generate, for each of the regions, weight mode information indicating a weight mode determined by the weight mode determination unit; and

an encoding unit configured to encode the weight mode information generated by the weight mode information generation unit.

(2) The image processing device according to (1), wherein the weight mode includes weight ON mode in which the inter-motion prediction compensation processing is performed using the weight coefficient and weight OFF mode in which the inter-motion prediction compensation processing is performed without using the weight coefficient.
(3) The image processing device according to (1) or (2), wherein the weight mode includes a mode using the weight coefficient and performing the inter-motion prediction compensation processing in Explicit mode for transmitting the weight coefficient and a mode using the weight coefficient and performing the inter-motion prediction compensation processing in Inplicit mode for not transmitting the weight coefficient.
(4) The image processing device according to any one of (1) to (3), wherein the weight mode includes multiple weight ON modes for performing the inter-motion prediction compensation processing using weight coefficients which are different from each other.
(5) The image processing device according to any one of (1) to (4), wherein the weight mode information generation unit generates, instead of the weight mode information, mode information indicating a combination of the weight mode and an inter-prediction mode indicating a mode of the inter-motion prediction compensation processing.
(6) The image processing device according to any one of (1) to (5) further comprising a limiting unit for limiting the size of the region for which the weight mode information generation unit generates the weight mode information.
(7) The image processing device according to any one of (1) to (6), wherein the region is a region of processing unit of the inter-motion prediction compensation processing.
(8) The image processing device according to any one of (1) to (7), wherein the region is Largest Coding Unit, Coding Unit, or Prediction Unit.
(9) The image processing device according to any one of (1) to (8), wherein the encoding unit encodes the weight mode information by CABAC.
(10) An image processing method of an image processing device,

wherein a weight mode determination unit determines, for each predetermined region, a weight mode which is a mode of weight prediction in which inter-motion prediction compensation processing for coding an image is performed while giving weight with a weight coefficient;

a weight mode information generation unit generates, for each of the regions, weight mode information indicating a weight mode determined by the weight mode determination unit; and

an encoding unit encodes the weight mode information generated.

(11) An image processing device,

wherein during coding of an image, a weight mode which is a mode of weight prediction in which inter motion prediction compensation processing is performed while giving weight with a weight coefficient is determined, for each predetermined region, weight mode information indicating a weight mode is generated for each of the regions, and a bit stream encoded together with the image is decoded,

the image processing device comprises: a decoding unit configured to extract the weight mode information included in the bit stream; and

a motion compensation unit configured to generate a prediction image by performing motion compensation processing in a weight mode indicated in the weight mode information extracted through decoding by the decoding unit.

(12) The image processing device according to (11), wherein the weight mode includes weight ON mode in which the motion compensation processing is performed using the weight coefficient and weight OFF mode in which the motion compensation processing is performed without using the weight coefficient.
(13) The image processing device according to (11) or (12), wherein the weight mode includes a mode in which, using the weight coefficient, the motion compensation processing is performed in Explicit mode for transmitting the weight coefficient and a mode in which, using the weight coefficient, the motion compensation processing is performed in inplicit mode for not transmitting the weight coefficient.
(14) The image processing device according to any one of (11) to (13), wherein the weight mode includes multiple weight ON modes for performing the motion compensation processing using weight coefficients which are different from each other.
(15) The image processing device according to any one of (11) to (14), wherein in a case of inplicit mode not transmitting the weight coefficient, the image processing device further includes a weight coefficient calculation unit configured to calculate the weight coefficient.
(16) The image processing device according to any one of (11) to (15) further comprising a limitation information obtaining unit configured to obtain limitation information limiting a size of a region where Weight mode information exists.
(17) The image processing device according to any one of (11) to (16), wherein the region is a region of processing unit of the inter-motion prediction compensation processing
(18) The image processing device according to any one of (11) to (17), wherein the region is Largest Coding Unit, Coding Unit, or Prediction Unit.
(19) The image processing device according to any one of (11) to (18), wherein a bit stream including the weight mode information is encoded by CABAC, and the decoding unit decodes the bit stream by CABAC.
(20) An image processing method for an image processing unit,

wherein during coding of an image, a weight mode which is a mode of weight prediction in which inter motion prediction compensation processing is performed while giving weight with a weight coefficient is determined, for each predetermined region, weight mode information indicating a weight mode is generated for each of the regions,

the image processing method comprises:

causing the decoding unit to decode a hit stream encoded together with the image, and extract the weight mode information included in the bit stream; and

causing a motion compensation unit to generate a prediction image by performing motion compensation processing in a weight mode indicated in the weight mode information extracted through decoding.

### REFERENCE SIGNS LIST

100 image coding device, 115 motion prediction/compensation unit, 121 weight prediction unit, 122 weight mode determination unit, 161 weight coefficient determination unit, 162 weighted motion compensation unit, 200 image decoding device, 212 motion prediction/compensation unit, 257 weight mode information buffer, 258 control unit, 321 weight prediction unit 323 region size limiting unit, 361 weight coefficient determination unit, 362 weighted motion compensation unit, 412 motion prediction/compensation unit, 451 region size limitation information buffer, 458 control unit, 515 motion prediction/compensation unit, 521 weight prediction unit 552 cost function value generation unit, 553 mode determination unit, 562 weighted motion compensation unit, 615 motion prediction/compensation unit, 621 weight prediction unit, 622 weight mode determination unit, 651 motion search unit, 652 cost function value generation unit, 653 mode determination unit, 662 weighted motion compensation unit, 663 cost function value generation unit

1. An image processing device comprising: a weight mode determination unit configured to determine, for each predetermined region, a weight mode which is a mode of weight prediction in which inter-motion prediction compensation processing for coding an image is performed while giving weight with a weight coefficient;
a weight mode information generation unit configured to generate, for each of the regions, weight mode information indicating a weight mode determined by the weight mode determination unit; and
an encoding unit configured to encode the weight mode information generated by the weight mode information generation unit.

2. The image processing device according to claim 1, wherein the weight mode includes weight ON mode in which the inter-motion prediction compensation processing is performed using the weight coefficient and weight OFF mode in which the inter-motion prediction compensation processing is performed without using the weight coefficient.

3. The image processing device according to claim 1, wherein the weight mode includes a mode using the weight coefficient and performing the inter-motion prediction compensation processing in Explicit mode for transmitting the weight coefficient and a mode using the weight coefficient and performing the inter-motion prediction compensation processing in Inplicit mode for not transmitting the weight coefficient.

4. The image processing device according to claim 1, wherein the weight mode includes multiple weight ON modes for performing the inter-motion prediction compensation processing using weight coefficients which are different from each other.

5. The image processing device according to claim 1, wherein the weight mode information generation unit generates, instead of the weight mode information, mode information indicating a combination of the weight mode and an inter-prediction mode indicating a mode of the inter-motion prediction compensation processing.

6. The image processing device according to claim 1 further comprising a limiting unit for limiting the size of the region for which the weight mode information generation unit generates the weight mode information.

7. The image processing device according to claim 1, wherein the region is a region of processing unit of the inter-motion prediction compensation processing.

8. The image processing device according to claim wherein the region is Largest Coding Unit, Coding Unit, or Prediction Unit.

9. The image processing device according to claim 1, wherein the encoding unit encodes the weight mode information by CABAC.

10. An image processing method of an image processing device,
wherein a weight mode determination unit determines, for each predetermined region, a weight mode which is a mode of weight prediction in which inter-motion prediction compensation processing for coding an image is performed while giving weight with a weight coefficient;
a weight mode information generation unit generates, for each of the regions, weight mode information indicating a weight mode determined by the weight mode determination unit; and
an encoding unit encodes the weight mode information generated.

11. An image processing device,
wherein during coding of an image, a weight mode which is a mode of weight prediction in which inter motion prediction compensation processing is performed while giving weight with a weight coefficient is determined, for each predetermined region, weight mode information indicating a weight mode is generated for each of the regions, and a bit stream encoded together with the image is decoded,
the image processing device comprises: a decoding unit configured to extract the weight mode information included in the bit stream; and
a motion compensation unit configured to generate a prediction image by performing motion compensation processing in a weight mode indicated in the weight mode information extracted through decoding by the decoding unit.

12. The image processing device according to claim 11, wherein the weight mode includes weight ON mode in which the motion compensation processing is performed using the weight coefficient and weight OFF mode in which the motion compensation processing is performed without using the weight coefficient.

13. The image processing device according to claim 11, wherein the weight mode includes a mode in which, using the weight coefficient, the motion compensation processing is performed in Explicit mode for transmitting the weight coefficient and a mode in which, using the weight coefficient, the motion compensation processing is performed in Inplicit mode for not transmitting the weight coefficient.

14. The image processing device according to claim 11, wherein the weight mode includes multiple weight ON modes for performing the motion compensation processing using weight coefficients which are different from each other.

15. The image processing device according to claim 11, wherein in a case of Inplicit mode not transmitting the weight coefficient, the image processing device further includes a weight coefficient calculation unit configured to calculate the weight coefficient.

16. The image processing device according to claim 11 further comprising a limitation information obtaining unit configured to obtain limitation information limiting a size of a region where weight mode information exists.

17. The image processing device according to claim 11, wherein the region is a region of processing unit of the inter-motion prediction compensation processing

18. The image processing device according to claim 11, wherein the region is Largest Coding Unit, Coding Unit, or Prediction Unit.

19. The image processing device according to claim 11, wherein a bit stream including the weight mode information is encoded by CABAC, and the decoding unit decodes the bit stream by CABAC.

20. An image processing method for an image processing unit,
wherein during coding of an image, a weight mode which is a mode of weight prediction in which inter-motion prediction compensation processing is performed while giving weight with a weight coefficient is determined, for each predetermined region, weight mode information indicating a weight mode is generated for each of the regions,
the image processing method comprises:
causing the decoding unit to decode a bit stream encoded together with the image, and extract the weight mode information included in the bit stream; and
causing a motion compensation unit to generate a prediction image by performing motion compensation processing in a weight mode indicated in the weight mode information extracted through decoding.
